(19) United States
(12) Patent Application Publication
(10) Pub. No.: US 2005/0228153 A1
(43) Pub. Date: Oct. 13, 2005

(54) Optical recording material, optical recording medium and optical recording/reproducing device

(75) Inventors: Jiro Minabe, Ashigarakami-gun (JP); Tatsuya Maruyama, Minato-ku (JP); Hiroo Takizawa, Minamiashigara-shi (JP)

Correspondence Address: OLIFF & BERRIDGE, PLC, P.O. BOX 19928, ALEXANDRIA, VA, 22320, US

(73) Assignee: FUJI XEROX CO. LTD.

(21) Appl. No.: 10/989,344

(22) Filed: Nov. 17, 2004

(30) Foreign Application Priority Data
Apr. 7, 2004 (JP) 2004-113463

(51) Int. Cl. C08F 20/42

(52) U.S. Cl. 526/298

(57) ABSTRACT

Provided are an optical recording material for recording information based on a photoirradiation-induced change in absorption, refractive index or shape, an optical recording material containing a photoresponsive group-containing polymer or oligomer which includes a main chain and a mesogen group-containing side chain linked to the main chain, wherein at least two main-chain spacer groups having flexibility and different lengths are introduced into the main chain; an optical recording medium having a photosensitive layer containing the optical recording material; and an optical recording/reproducing device which uses the optical recording medium in recording and/or reproducing information. All or part of the mesogen group is preferably a photoresponsive group.

### CROSS-REFERENCE TO RELATED APPLICATION

This application claims priority under 35 USC 119 from Japanese Patent Application No. 2004-113463, the disclosure of which is incorporated by reference herein.

### BACKGROUND OF THE INVENTION

1. Field of the Invention

The present invention relates to an optical recording material, an optical recording medium and an optical recording/reproducing device. In particular, the invention relates to a volume-type optical recording medium having a large-capacity, an optical recording material for use in such an optical recording medium, and an optical recording/reproducing device which uses such an optical recording medium for purpose of recording and reproducing information.

2. Description of the Related Art

In order to secure an increasingly high level of recording density, conventional, high-density, large-capacity, optical disc storage devices have been designed so as to have a small beam-spot diameter and a short distance between adjacent tracks or pits. However, the in-plane recording of data on such an optical disc is restricted by the diffraction limit of light, and the conventional high density recording is now approaching its physical limits (5 Gbit/in²). Thus, three-dimensional (volume) recording (including recording in the depth direction) is necessary to secure a further increase in capacity.

As a volume-type optical recording medium of the type mentioned above, a medium comprising a photorefractive material (a photorefractive material medium) on which volume recording of holographic gratings can be performed is regarded as promising. It is known that some photorefractive materials (hereinafter referred to as “PR materials”) have a high degree of sensitivity, and therefore they can change their refractive index by absorbing relatively weak light to the same extent as a solid-state laser. Such materials are expected to be applied to volume-multiplexed holographic recordings (holographic memories) which can assume an ultra-high density and an ultra-large capacity.

The principle of the photorefractive effect is now described. Two coherent lightwaves are applied to the PR material to form interference. In places where light intensity is high, electrons at the donor level are excited to the conduction band and either diffuse or drift into a place where light intensity is low. Positive charges are left in places where light intensity is high, and negative charges accumulate in places where light intensity is low. Thus, charge distribution is formed to create an electrostatic field. The electro-optical effects of the electrostatic field result in variations in the refractive index. The cycle of variations in the refractive index is the same as the cycle of the interference fringes, and refractive index gratings act as holographic diffraction gratings.

Conventionally, inorganic ferroelectric crystal materials such as barium titanate, lithium niobate and bismuth silicate (BSO) have often been used as the PR material. These materials can demonstrate a photo-induced refractive index-varying effect (photorefractive effect) with a high level of sensitivity and a high degree of efficiency. On the other hand, these materials also entail a number of disadvantages, insofar that crystal growth has proved difficult in the case of many of these materials, many of the materials are also hard and brittle, and thus cannot be worked into a desired shape, and regulation of sensitive wavelengths has also proved difficult.

In recent years, organic PR materials have been proposed for overcoming such disadvantages. In general, such organic PR materials are composed of (i) a charge-generating material that generates charges on receiving light; (ii) a charge transfer material that stimulates the transfer of generated charges inside a medium; (iii) a dichroic organic dye which is sensitive to the electric field induced by the transfer of charges; (iv) a polymer substrate (binder) which supports these materials; and (v) additives (such as plasticizers and compatibility-improving agents) for modifying the physical properties of the substrate. A single component may play different roles, for example, as both the charge transfer material and the polymer substrate, or as the charge transfer material and the plasticizer.

In such organic PR materials, the charge-generating material absorbs light to generate both positive and negative charges. The charge transfer material enables the charges to separate into positive and negative charges by means of the action of the existing outer electric field, and an inner electric field is thus produced. The inner electric field produces variations in the orientation of the dichroic dye, which leads to variations in refractive index distribution within the substrate. With the use of such organic PR materials, therefore, high-density volume holographic recording is in theory considered to be possible.

However, such organic PR materials entail a problem insofar that they inherently require the application of an outer electric field. The electric field is as remarkably large as several hundreds V·mm⁻¹, and in the practical use of the material system for recording devices this imposes a severe restriction on the size of devices. Insofar that a mixture of several different materials including the charge-generating material, the charge transfer material and the polymer substrate, this material system also involves a significant problem in the shape of a reduction in stability, caused by phase separation during recording or storage.

In order to avoid the foregoing problems, for example, S. Hvilsted et al. have proposed holographic recordings in which refractive index gratings are written with the use of a polymer having cyanoazobenzene in its side chain (for example, see Opt. Lett., 17[17], 1234-1236, 1992). In this material, for example, 2500 high and low refractive index gratings can be written within a space of 1 mm. Thus, this material is expected to achieve a high degree of recording density.

The holographic memory to a polymer film having azobenzene in its side chain is based on photo-induced anisotropy of the polymer film. In the amorphous azopolymer film, the azobenzene has a random orientation. When linearly polarized light with a wavelength corresponding to the absorption band which belongs to the π-π* transition of the azo group is applied to the azopolymer film as excitation light, as the transition dipole moment approaches the polarization direction (in other words, as selective excitation occurs), there is a greater probability of azobenzene having trans-form being photoisomerized into one having cis-form. The cis-form thus excited can also be isomerized back into a trans-form by light or heat.

After the angle-selective trans-cis-trans isomerization cycle has been achieved by means of the application of polarized light, an orientation of the azobenezene is shifted towards a direction that is stable against the excitation light, specifically towards a direction perpendicular to the polarization direction. As a result of this change in orientation, an azobenzene having optical anisotropy exhibits birefringence or dichroism. With the use of such photo-induced anisotropy, holographic recording is possible by means of intensity distribution or polarization distribution. Since the record is formed by means of this change in polymer orientation, the record is stable over a long period of time and can be erased by the application of circularly polarized light, or by heating the isotropic phase. Rewriting therefore become possible. The film of such a polymer having azobenzene in its side chain is the most promising material for rewritable holographic memories.

As such a material, some holographic recording materials are disclosed which contain an azobenzene-containing polymer having in a side chain an azobenzene moiety with a specific structure and having an acrylate or a methacrylate structure as a main chain. However, such materials still entail a problem which will be described later, and it is difficult to form a thick film medium that can achieve a high degree of diffraction efficiency. Such materials have not proved to be sufficient for optical recording media having high density- and high sensitivity-properties (for example, see Japanese Patent Applications National Publication (Laid-Open) Nos. 2000-514468 and 2002-539476, U.S. Pat. No. 6,441,113 B1 and Japanese Patent Application Laid-Open (JP-A) No. 10-212324). Particularly in the application of a conventional azobenzene-containing polymer as a volume holographic material in which a number of holograms are formed in an optical recording medium, it has proved difficult to produce a thick film medium capable of achieving both a high degree of diffraction efficiency and a high level of digital data recording speed. In practical media, the film thickness limit has been about 40 μm (for example, see H. J. Coufal, D. Psaltis, G. T. Sincerbox eds., Holographic Data Storage, Springer, p. 209-228, [2000]).

The inventors have already proposed a polyester having azobenzene in its side chain, which, as mentioned above, can be useful as an optical recording material. More specifically, a monomer has been disclosed whose absorption band is controlled, by the introduction to azobenzene of a methyl group, within a certain region suitable for optical recording, as well as a polyester thereof and an optical recording medium using these materials (for example, see JP-A No. 2000-109719). The inventors have also proposed a polyester suitable for optical recording, a polyester which has a specified methylene chain in its main chain and has a controlled glass transition temperature, and an optical recording medium using the polyester (for example, see JP-A No.2000-264962). It has also been disclosed that a polyester having a specified methylene chain in its side chain can secure improved optical recording characteristics (for example, see JP-A No. 2001-294652).

With regard to volume-type holographic memories, making a thick film for recording media is most important for purposes of achieving large capacity. In general, as the thickness of a hologram increases, the incident angle conditions for diffraction become severer, and even a slight deviation from the Bragg condition can lead to a loss of diffracted light. The angle-multiplexed method for volume-type holographic memories is based on this angle selectivity. In such a method, a number of holograms are formed within the same material, and since the incident angle of the readout light can be regulated, a desired hologram can be read out with no crosstalk. If angle selectivity is improved by increasing the film thickness of the recording medium, multiplicity can be increased and recording capacity can accordingly also be enhanced.

The magnitude of refractive index modulation for forming holograms has a limit depending on the capacity of the medium material. Therefore, production of a number of holograms within the same material means that when the holograms are used this may be tantamount to the refractive index-modulating capacity of the material being reduced in relation to the number of holograms. Diffraction efficiency can be a function of almost the square of the refractive index amplitude. Therefore, when multiplicity is increased, the diffraction efficiency of the hologram can decrease in proportion to the square of the multiplicity. Therefore, it is desirable to develop a recording medium which can secure a reasonable level of diffraction efficiency even when the degree of multiplicity is increased.

On the other hand, a polymer film having azobenzene in its side chain requires a recording wavelength capable of exciting the π-π* transition of the azobenzene according to the above-mentioned mechanism. The selection of a high-absorption wavelength ought to be effective for purposes of enhansing recording sensitivity. However, a high-absorption capacity can also result in the occurrence of another problem at the same time. If a material is used that has a high capacity of absorption at the recording wavelength, the incident recording light may be absorbed by molecules in a vicinity of the surface of the medium, and accordingly holograms can no longer be effectively formed over the entire area in a film thickness direction of the medium. It is known that if the refractive index amplitude for a hologram is impaired in the film thickness direction, angle selectivity for diffraction efficiency may be adversely affected. Such a degradation in angle selectivity can lead to crosstalk between multi-recorded holograms, and thus lead to a reduction in the S/N ratio. In addition, it can become difficult to achieve a high degree of diffraction efficiency because of absorption loss in the medium.

In a polyester used for the optical recording material that uses a polyester containing a methylene chain as, for example, a spacer group introduced into a main chain of the polyester (hereinafter also referred to as a “main-chain spacer group”), or a spacer group introduced into a side chain of the polyester (hereinafter also referred to as a “side-chain spacer group”), if, for example, the spacer group introduced is relatively short, the start of photo-induced birefringence can be quick, but the saturation value can be small because of the strong binding force of the main chain on the side chain. On the other hand, if the spacer group introduced is made relatively long, the start can be slow, but the side chain may cause substantial variations in orientation because of the long spacer group, resulting in the production of a high degree of birefringence. Thus, it has proved difficult to achieve a high degree of sensitivity and at the same time a large dynamic range.

### SUMMARY OF THE INVENTION

The present invention has been made in view of the above problems. The invention provides an optical recording material which has a controlled length of a main-chain spacer group so that it can maintain a high degree of recording sensitivity, a large dynamic range and a high level of diffraction efficiency, and can form a thick film. The invention also provides an optical recording medium which has a thick photosensitive layer with no degradation in recording characteristics, thus ensuring that large-capacity recording can be performed on it. The invention also provides an optical recording/reproducing device with which recording and reproduction of large-capacity data can be performed.

Thus, as a first embodiment, the invention provides an optical recording material for recording information on the basis of a photoirradiation-induced change in absorption, refractive index or shape, comprising: a photoresponsive group-containing polymer or polymers or a photoresponsive group-containing oligomer or oligomers, the polymer or the polymers or the oligomer or the oligomers comprising a main chain or main chains and a mesogen group-containing side chain or side chains linked to the main chain or main chains, wherein at least two main-chain spacer groups having flexibility and different lengths are introduced into the main chain or into the main chains.

Further, as a second embodiment, the invention provides an optical recording medium, which comprises a photosensitive layer which contains the optical recording material.

Furthermore, as a third embodiment, the invention provides an optical recording/reproducing device, which uses the optical recording medium in recording and/or reproducing information.

### BRIEF DESCRIPTION OF THE DRAWINGS

Preferred embodiments of the present invention will be described in detail on the basis of basis of the following figures.

FIG. 1 is a schematic diagram showing an example of the optical recording/reproducing device of the invention.

FIG. 2 is a cross-sectional view showing the structure of a spatial modulator used in the optical recording/reproducing device of the invention.

FIG. 3 is a schematic diagram showing another example of the optical recording/reproducing device of the invention.

FIG. 4 is a schematic diagram showing yet another example of the optical recording/reproducing device of the invention.

FIG. 5 is a graph showing variations in photo-induced birefringence against light exposure energy.

FIG. 6 is a graph showing the relation between the blend ratio of a photoresponsive polyester and sensitivity or birefringence.

FIG. 7 is a graph showing the relation between the blend ratio of a photoresponsive polyester and (sensitivity×birefringence).

FIG. 8 is a graph showing variations in diffracted light intensity against deviation from the Bragg angle.

FIG. 9 is a graph showing the relation between an absorption coefficient and an attenuation coefficient of grating.

### DETAILED DESCRIPTION OF THE INVENTION

The present invention is described in detail below.

Optical Recording Material

The invention is directed to an optical recording material for recording information on the basis of photoirradiation-induced variation in absorption, refractive index or shape, an optical recording material which includes a photoresponsive group-containing polymer, or polymers, or a photoresponsive group-containing oligomer, or oligomers, wherein the polymer, or polymers, or the oligomer, or oligomers, contain a main chain, or main chains, and a mesogen group-containing side chain, or side chains, linked to the main chain, or main chains, and wherein two or more main-chain spacer groups having flexibility and different lengths are introduced into the main chain, or main chains.

When irradiated with light, the photoresponsive group causes a change in structure, such as geometric isomerization. For example, the photoresponsive group may include an azobenzene skeleton, a stilbene skeleton or an azomethine skeleton (described later in detail), but preferably includes an azobenzene skeleton.

Preferred examples of the mesogen group include linear mesogen groups that are used for conventional low-molecular liquid crystals, such as a biphenyl group including a p (para)-substituted aromatic ring, a terphenyl group, a benzoate group, a cyclohexyl carboxylate group, a phenylcyclohexane group, a pyrimidine group, a dioxane group, and a cyclohexylcyclohexane group. A biphenyl skeleton-containing group (biphenyl derivative) is more preferred.

In the invention, a photoresponsive group such as azobenzene, as described above, may be incorporated into the mesogen group.

The optical recording material of the invention has the following features: the mesogen group-containing side chain(s) is linked to the main chain(s), and two or more main-chain spacer groups having flexibility and different lengths are introduced into the main chain(s), so that a high degree of sensitivity and a large dynamic range can be achieved at the same time.

Specifically, two or more main-chain spacer groups having flexibility and different lengths are introduced into the main chain(s) so that the relatively short main-chain spacer group can trigger a relatively rapid rise in photo-induced birefringence and so that a relatively large saturation value of birefringence can be obtained by means of the relatively long main-chain spacer group. Thus, even in the case of a thick film, a high degree of sensitivity and a large dynamic range can be achieved at the same time.

In the context of this invention, the phrase “having flexibility” means having flexibility such that plural bonded atoms can move to a certain degree or more by virtue of molecular motion, as in a process such as ether linkage or a methylene chain.

In a preferred mode, for example, an alkylene group of from 2 to 12 carbon atoms is introduced as the relatively short main-chain spacer group, and an alkylene group of from 4 to 20 carbon atoms is introduced as the relatively long main-chain spacer group. Thus, a rapid quick rise in photo-induced birefringence and a substantial saturation value can be achieved at the same time.

The length ratio of the long main-chain spacer group in relation to the short main-chain spacer group is preferably from about 10:9 to about 10:1, and more preferably from about 6:4 to about 4:1.

In the context of the invention, the sentence “two or more main-chain spacer groups having flexibility and different lengths are introduced into the main chain or chains” means that the main chain or chains including the two or more spacer groups different in length exist throughout the entirety of the polymer or polymers, or throughout the entirety of the oligomer or oligomers.

In the invention, therefore, the introduction into the main chain or chains of the main-chain spacer groups having different lengths may be achieved by linking in a block manner into a single main polymer chain spacer groups having flexibility and different lengths, or alternatively may be achieved by mixing polymers or oligomers into whose main chains spacer groups with flexibility and different lengths have been introduced. Even in the latter case, effects can be expected which are on a par with a case where two or more spacer groups which are different in length are introduced into a single polymer.

Moerover, the former and latter cases should be the same in terms of preferred lengths of the main-chain spacer groups, their length ratio, and their content ratio.

In the invention, all or part of the mesogen group is preferably a photoresponsive group at those described above. The structural change on the basis of photochemical reaction of such a photoresponsive group can induce an effective change in the orientation of either the polymer or the oligomer.

Examples of the mesogen group also serving as the photoresponsive group are described later.

The content of the mesogen group serving as the photoresponsive group in all of the mesogen groups is preferably from about 0.01 to about 80% by mole, and more preferably from about 1 to about 60% by mole.

In a preferable embodiment of the invention, the side chains include a first side chain containing a photoresponsive mesogen group, as described above, and a second side chain containing a non-photoresponsive mesogen group; the photoresponsive group-containing side chain (the first side chain) is linked to the main chain having a first main-chain spacer group; the non-photoresponsive group-containing side chain (the second side chain) is linked to the main chain having a second main-chain spacer group; and the first and second main-chain spacer groups differ in length.

In such circumstance, the mobility of the photoresponsive group which directly changes its structure when irradiated with light and the mobility of the non-photoresponsive group, which varies its orientation as the photoresponsive group changes its structure, can each independently be regulated.

In a particularly preferable embodiment of the invention, the length of the main-chain spacer group to which the photoresponsive group-containing side chain is linked is shorter than that of the main-chain spacer group to which the non-photoresponsive group-containing side chain is linked. If in this way the main-chain spacer group to which the photoresponsive group-containing side chain is linked is relatively short, the rise in photo-induced birefringence can be speeded up, and by making the main-chain spacer group to which the non-photoresponsive group-containing side chain is linked relatively long, the birefringence saturation value can be enhanced.

In such a case, the preferred lengths of the long and short main-chain spacer groups, the length ratio between the long and short main-chain spacer groups and the content ratio between the long and short main-chain spacer groups may all be the same as in the case of the main-chain spacer groups described above.

The photoresponsive group-containing polymer or oligomer according to the invention is described in detail below.

In the invention, the photoresponsive group-containing polymer or oligomer is preferably a compound represented by Formula (1): 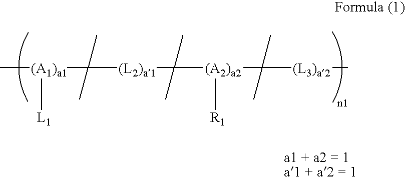
wherein each of L₁ to L₃ represents a bivalent linking group, R₁ represents a hydrogen atom or a substituent, P₁ represents a photoresponsive moiety-containing group, a1 is from 0.0001 to 1, a2 is from 0 to 0.9999, a′1 is from 0.0001 to 0.9999, a′2 is from 0.0001 to 0.9999, and n1 is from 4 to 2000.

In the invention, the mesogen group-containing side chain is linked to the main chain. Accordingly, at least one of L₁-P₁ and R₁ in Formula (1) must contain the mesogen group. In such a case, the photoresponsive group in P₁, as described later, may also function as the mesogen group.

In Formula (1), each of L₁ to L₃ represents a bivalent linking group. Each of L₁ to L₃ may represent a linking group of 0 to 100 carbon atoms, preferably of 1 to 20 carbon atoms, a linking group which comprises one or any combination of an alkylene group (preferably alkylene of 1 to 20 carbon atoms, such as optionally substituted methylene, ethylene, propylene, butylene, pentylene, hexylene, octylene, decylene, undecylene, and —CH₂PhCH₂— (wherein Ph represents phenylene)), an alkenylene group (preferably alkenylene of 2 to 20 carbon atoms, such as ethenylene, propenylene and butadienylene), an alkynylene group (preferably alkynylene of 2 to 20 carbon atoms, such as ethynylene, propynylene and butadiynylene), a cycloalkylene group (preferably cycloalkylene of 3 to 20 carbon atoms, such as 1,3-cyclopentylene and 1,4-cyclohexylene), an arylene group (preferably arylene of 6 to 26 carbon atoms, such as optionally substituted 1,2-phenylene, 1,3-phenylene, 1,4-phenylene, 1,4-naphthylene, and 2,6-naphthylene), a heterylene group (preferably heterylene of 1 to 20 carbon atoms, such as a bivalent group formed by extracting two hydrogen atoms from optionally substituted pyridine, pyrimidine, triazine, piperazine, pyrrolidine, piperidine, pyrrole, imidazole, triazole, thiophene, furan, thiazole, oxazole, thiadiazole, or oxadiazole), an amide group, an ester group, a sulfonamide group, a sulfonate group, a ureido group, a sulfonyl group, a sulfinyl group, a thioether group, an ether group, an imino group, and a carbonyl group.

According to the invention, each of L₂ and L₃ functions as a spacer group, and a spacer group, either L₂ or L₃, preferably comprises methylene chains which are optionally spaced by a bivalent substituent(s). L₂ and L₃ may also each contain a rigid moiety such as an aromatic ring. According to the invention, L₂ and/or L₃ contain two or more introduced spacer groups having flexibility and different lengths.

In Formula (1), R₁ represents a hydrogen atom or a substituent. Preferred Examples of the substituent include an alkyl group (preferably alkyl of 1 to 20 carbon atoms, such as methyl, ethyl, n-propyl, isopropyl, n-butyl, n-pentyl, benzyl, 3-sulfopropyl, carboxymethyl, trifluoromethyl, and chloromethyl); an alkenyl group (preferably alkenyl of 2 to 20 carbon atoms, such as vinyl, allyl, 2-butenyl, and 1,3-butadienyl); a cycloalkyl group (preferably cycloalkyl of 3 to 20 carbon atoms, such as cyclopentyl and cyclohexyl); an aryl group (preferably aryl of 6 to 20 carbon atoms, such as phenyl, 2-chlorophenyl, 4-methoxyphenyl, 3-methylphenyl, 1-naphthyl, a biphenyl derivative, and a terphenyl derivative); a heterocyclic group (preferably a heterocyclic group of 1 to 20 carbon atoms, such as pyridyl, pyrimidyl, thienyl, furyl, thiazolyl, imidazolyl, pyrazolyl, pyrrolidino, piperidino, and morpholino); an alkynyl group (preferably alkynyl of 2 to 20 carbon atoms, such as ethynyl, 2-propynyl, 1,3-butadiynyl, and 2-phenylethynyl); a halogen atom (such as F, Cl, Br, and I); an amino group (preferably an amino group of 0 to 20 carbon atoms, such as amino, dimethylamino, diethylamino, dibutylamino, and anilino); a cyano group; a nitro group; a hydroxyl group; a mercapto group; a carboxyl group; a sulfo group; a phosphonic acid group; an acyl group (preferably acyl of 1 to 20 carbon atoms, such as acetyl, benzoyl, salicyloyl; and pivaloyl); an alkoxy group (preferably alkoxy of 1 to 20 carbon atoms, such as methoxy, butoxy and cyclohexyloxy); an aryloxy group (preferably aryloxy of 6 to 26 carbon atoms, such as phenoxy and 1-naphthoxy); an alkylthio group (preferably alkylthio of 1 to 20 carbon atoms, such as methylthio and ethylthio), arylthio (preferably arylthio of 6 to 20 carbon atoms, such as phenylthio and 4-chlorophenylthio); an alkylsulfonyl group (preferably alkylsulfonyl of 1 to 20 carbon atoms, such as methanesulfonyl and butanesulfonyl); an arylsulfonyl group (preferably arylsulfonyl of 6 to 20 carbon atoms, such as benzenesulfonyl and para-toluenesulfonyl); a sulfamoyl group (preferably sulfamoyl of 0 to 20 carbon atoms, such as sulfamoyl, N-methylsulfamoyl and N-phenylsulfamoyl); a carbamoyl group (preferably carbamoyl of 1 to 20 carbon atoms, such as carbamoyl, N-methylcarbamoyl, N,N-dimethylcarbamoyl, and N-phenylcarbamoyl); an acylamino group (preferably acylamino of 1 to 20 carbon atoms, such as acetylamino and benzoylamino); an imino group (preferably imino of 2 to 20 carbon atoms, such as phthalimino); an acyloxy group (preferably acyloxy of 1 to 20 carbon atoms, such as acetyloxy and benzoyloxy); an alkoxycarbonyl group (preferably alkoxycarbonyl of 2 to 20 carbon atoms, such as methoxycarbonyl and phenoxycarbonyl); a carbamoylamino group (preferably carbamoylamino of 1 to 20 carbon atoms, such as carbamoylamino, N-methylcarbamoylamino and N-phenylcarbamoylamino); and an azo group (preferably an azo group of 1 to 20 carbon atoms, such as phenylazo and naphthylazo). R₁ more preferably represents a hydrogen atom, an alkyl group, an aryl group, a heterocyclic group, a halogen atom, an amino group, a cyano group, a nitro group, a hydroxyl group, a carboxyl group, an alkoxy group, an aryloxy group, an alkylsulfonyl group, an arylsulfonyl group, a sulfamoyl group, a carbamoyl group, an acylamino group, an acyloxy group, an alkoxycarbonyl group, or an azo group.

R₁ preferably contains one or more bivalent linking groups as represented by L₁.

If R₁ is a mesogen group-containing side chain, the mesogen group of R₁ should preferably be a non-photoresponsive group. Preferred examples of such a mesogen group include linear mesogen groups that can be used for conventional low-molecular liquid crystals, such as a biphenyl group including a p (para)-substituted aromatic ring, a terphenyl group, a benzoate group, a cyclohexyl carboxylate group, a phenylcyclohexane group, a pyrimidine group, a dioxane group, and a cyclohexylcyclohexane group.

In Formula (1), P₁ represents a photoresponsive moiety-containing group. In the invention, the photoresponsive moiety is preferably a compound moiety that can cause a structural change when absorbing light. The absorbed light is preferably ultraviolet light, visible light, or infrared light in a range of from about 200 nm to about 1000 nm, and more preferably ultraviolet light or visible light in a range of from about 200 nm to about 700 nm. In the invention, the photoresponsive moiety preferably has molar absorption coefficient anisotropy (dichroism) or refractive index anisotropy (inherent birefringence).

The photoresponsive moiety of P₁ preferably includes any one skeleton of azobenzene, stilbene, azomethine, stilbazolium, cinnamic acid (ester), chalcone, spiropyran, spirooxazine, diarylethene, fulgide, fulgimide, thioindigo, and indigo, more preferably comprises any one skeleton of azobenzene, spiropyran, spirooxazine, diarylethene, fulgide, and fulgimide, and is most preferably an azobenzene skeleton.

In a case where P₁ is an azobenzene skeleton-containing group, P₁ is preferably represented by the formula: —Ar₁—N═N—Ar₂, wherein Ar₂ represents an aryl group (preferably aryl of 6 to 26 carbon atoms, such as phenyl, 1-naphthyl and 2-naphthyl) or a heterocyclic group (preferably a heterocyclic group of 1 to 26 carbon atoms, such as pyridyl, pyrimidyl, pyrazyl, triazyl, pyrrolyl, imidazolyl, triazolyl, oxazolyl, thiazolyl, pyrazolyl, thienyl, furyl, isothiazolyl, oxadiazolyl, thiadiazolyl, and isooxazolyl).

The aryl or the heterocyclic group may have any substituent, and preferred examples of such a substituent include the substituents for R₁. The aryl or the heterocyclic group may form a fused ring. In such a case, the fused ring is preferably formed by fusing a benzene ring, a naphthalene ring, a pyridine ring, a cyclohexene ring, a cyclopentene ring, a thiophene ring, a furan ring, an imidazole ring, a thiazole ring, an isothiazole ring, an oxazole ring, or the like, and more preferably by fusing a benzene ring.

Preferred examples of the Ar₂ heterocyclic group include, but are not limited to, the groups shown below, wherein the bonding arm from each ring indicates the position where the azo group is substituted. 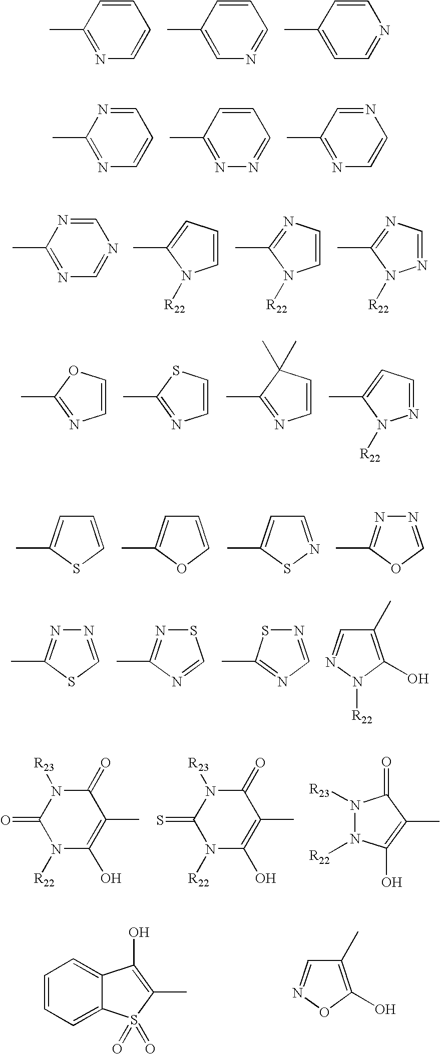
wherein each of R₂₂ and R₂₃ independently represents a hydrogen atom, an alkyl group, an alkenyl group, a cycloalkyl group, an aryl group, or a heterocyclic group (preferred examples of the substituent may be the same as those for R₁). Any hydrogen atom on the heterocyclic group may be replaced with any substituent, and preferred examples of such a substituent include the substituents for R₁.

Ar₁ represents an arylene group or a heterylene group. Preferred examples thereof include bivalent groups respectively formed by extracting a hydrogen atom from each of the preferred examples of the aryl group, or from the heterocyclic group for Ar₂.

When Ar₁ represents an arylene group, Ar₁ is more preferably 1,4-phenylene that may be optionally substituted. Ar₁ is more preferably an arylene group.

As stated above, in the invention the photoresponsive group may also be a mesogen group. Among the above groups, azobenzene, stilbene, azomethine, or the like may form the photoresponsive group capable of serving as the mesogen group.

The content of the photoresponsive group in the optical recording material of the invention is preferably about 20% by mass or less, and more preferably about 10% by mass or less relative to a total amount of the optical recording material. If the content of the photoresponsive group is more than 20% by mass, the degree of recording light absorption can increase so that in some cases effective optical recording becomes difficult. The lower limit to the content is preferably about 0.00001% by mass.

In Formula (1), a1 is from 0.0001 to 1, more preferably from 0.0001 to 0.5; a2 is from 0 to 0.9999, more preferably from 0.5 to 0.999; a′1 is from 0.0001 to 0.9999; a′2 is from 0.0001 to 0.9999; and n1 is an integer of 4 to 2000, more preferably of 10 to 2000.

In Formula (1), A₁ and A₂ each represents any one of the structures represented by Formulae (2-1) to (2-4):

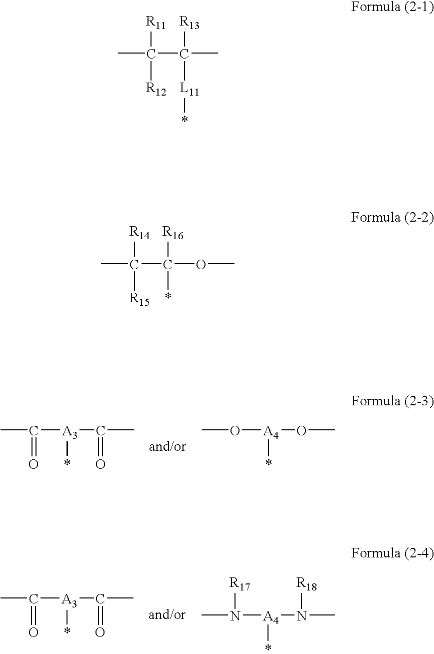

Any one of the structures represented by Formulae (2-1) to (2-4) is linked to L₁ or R₁ at the position indicated by the mark *. In Formula (2-1), each of R₁₁ to R₁₃ independently represents a hydrogen atom or a substituent; and L₁₁ represents either —O—, —OC(O)—, —CONR₁₉—, —COO— (wherein the left side of each group is linked to the main chain and the right side of each group is linked to either L₁ or R₁), or an optionally substituted arylene group, wherein R₁₉ represents any one of a hydrogen atom, an alkyl group, an alkenyl group, a cycloalkyl group, an aryl group, and a heterocyclic group. In Formula (2-2), each of R₁₄ to R₁₆ independently represents a hydrogen atom or a substituent. In Formulae (2-3) and (2-4), A₃ and A₄ each independently represents a trivalent linking group. In Formula (2-4), R₁₇ and R₁₈ each independently represents any one of a hydrogen atom, alkyl, alkenyl, cycloalkyl, aryl, and a heterocyclic group.

In Formula (2-1), each of R₁₁ to R₁₃ independently represents a hydrogen atom or a substituent, preferably a hydrogen atom, an alkyl group, an aryl group, or a cyano group, more preferably a hydrogen atom or a methyl group, still more preferably a hydrogen atom.

In Formula (2-1), L₁₁ represents either —O—, —OC(O)—, —CONR₁₉—, —COO— (wherein the left side of each group is linked to the main chain and the right side of each group is linked to either L₁ or R₁), or an optionally substituted arylene group (preferably arylene of 6 to 26 carbon atoms, such as 1,2-phenylene, 1,3-phenylene, 1,4-phenylene, 1,4-naphthylene, and 2,6-naphthylene), wherein R₁₉ represents any one of a hydrogen atom, an alkyl group, an alkenyl group, a cycloalkyl group, an aryl group, and a heterocyclic group (preferred examples of the substituent may be the same as those for R₁), and preferably represents a hydrogen atom or an alkyl group.

In Formula (2-2), each of R₁₄ to R₁₆ independently represents a hydrogen atom or a substituent, preferably a hydrogen atom or an alkyl group, more preferably a hydrogen atom or a methyl group.

In Formulae (2-3) and (2-4), each of A₃ and A₄ independently represents a trivalent linking group. Preferred examples of A₃ or A₄ include the following: 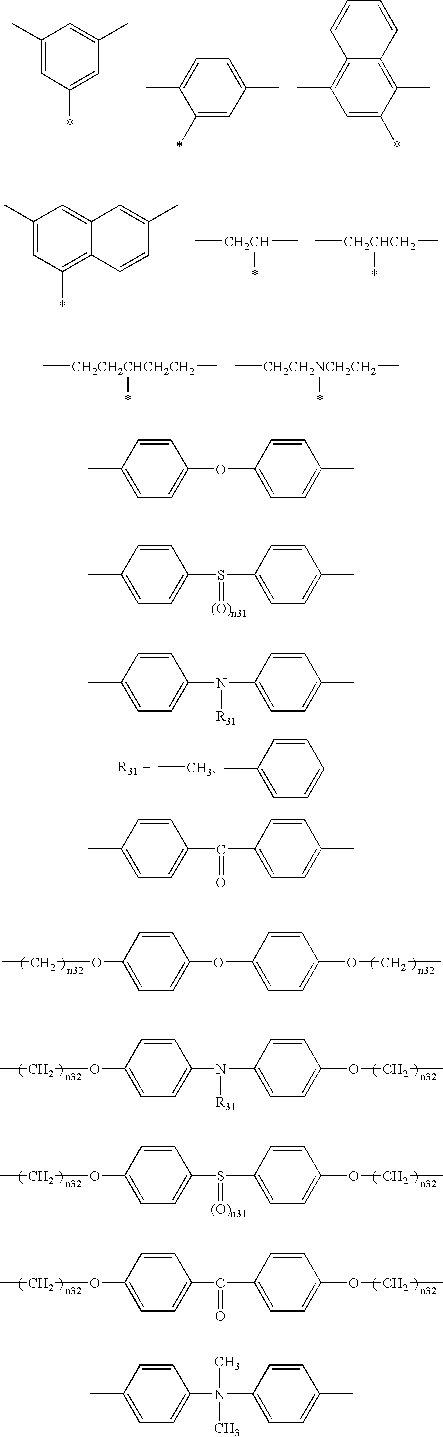 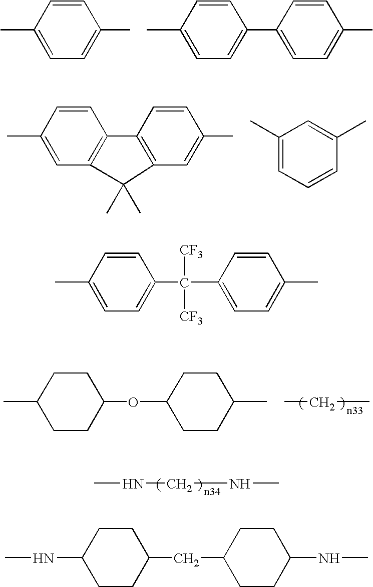
wherein n₃₁ is an integer of 0 to 2, n₃₂ is an integer of 2 to 12, n₃₃ is an integer of 2 to 12, and n₃₄ is an integer of 2 to 8.

In Formula (2-4), R₁₇ and R₁₈ each independently represents any one of a hydrogen atom, an alkyl group, an alkenyl group, a cycloalkyl group, an aryl group, and a heterocyclic group (preferred examples of the substituent may be the same as those for R₁).

A₁ or A₂ is preferably represented by Formula (2-1) or (2-3), more preferably by Formula (2-3).

In the invention, the main chain of the photoresponsive group-containing polymer or oligomer is not limited to any structure, but in a case where the main chain contains an organic group(s) having a cyclic structure, it is preferable that the photoresponsive group and/or the mesogen group is contained in the side chain(s), and that all or part of the side chain(s) is linked to all or part of the cyclic structure[s].

Such a structure can inhibit the production of liquid crystal, which could otherwise become the cause of scattering noise in a thick film medium.

In a case where the main chain contains an organic group having a cyclic structure, the polymer or oligomer represented by Formula (1) according to the invention preferably has a structure represented by Formula (3): 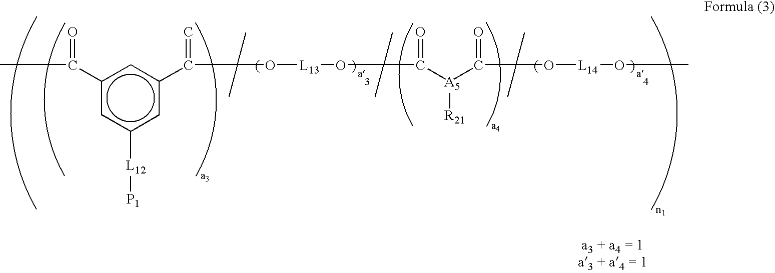
wherein P₁ and n1 have the same meanings as in Formula (1).

In Formula (3), R₂₁ represents a hydrogen atom or a substituent (preferred examples thereof may be the same as those for R₁), more preferably a hydrogen atom, an alkyl group, an aryl group, a heterocyclic group, a halogen atom, an amino group, a cyano group, a nitro group, a hydroxyl group, a carboxyl group, an alkoxy group, an aryloxy group, an alkylsulfonyl group, an arylsulfonyl group, a sulfamoyl group, a carbamoyl group, an acylamino group, an acyloxy group, or an alkoxycarbonyl group.

R₂₁ preferably contains one or more bivalent linking groups as represented by L₁.

Each of L₁₂ to L₁₄ is a bivalent linking group, and preferred examples thereof include those for L₁ to L₃ in Formula (1). In particular, L₁₃ and L₁₄ each functions as a spacer group in the same manner as L₂ and L₃ in Formula (1). A₅ represents a trivalent linking group, and preferred examples thereof include those for A₄.

The symbol a₃ is from 0.0001 to 1, and more preferably from 0.001 to 0.999, and a₄ is from 0 to 0.9999, and more preferably from 0.001 to 0.999.

The symbol a′₃ is from 0.0001 to 0.9999, and more preferably from 0.001 to 0.999, and a′₄ is from 0.0001 to 0.9999, and more preferably from 0.001 to 0.999.

In the invention, the polymer or oligomer having the structure represented by Formula (3) is particularly preferably a polyester represented by Formula (4): 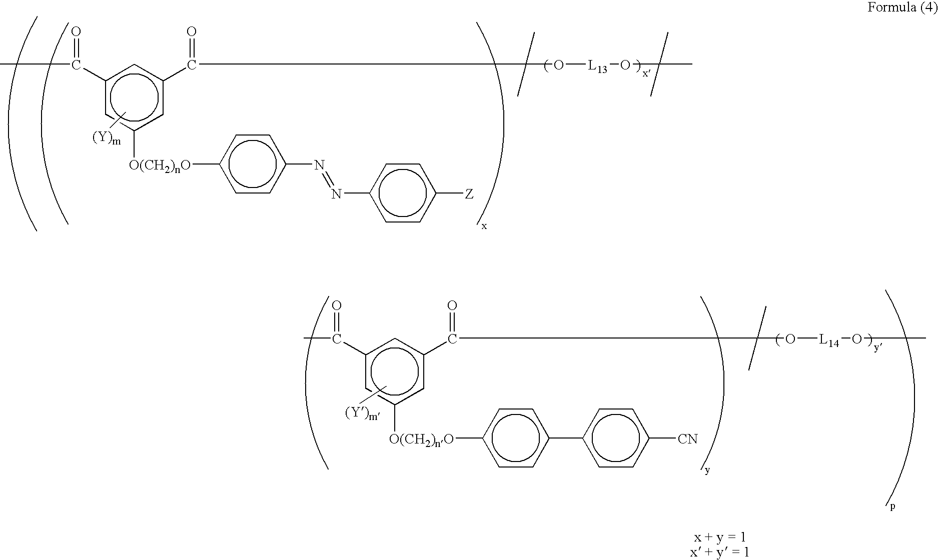
wherein Y and Y′ each independently represents a hydrogen atom or a lower alkyl grpup; Z and Z′ each independently represents a hydrogen atom, a methyl group, a methoxy group, a cyano group, or a nitro group; L₁₃ and L₁₄ each has the same meanings as defined above; m and m′ each independently represents an integer of 1 to 3; n and n′ each independently represents an integer of 2 to 18; p represents an integer of 5 to 2000; x and y each represents the abundance ratio of each repeating unit and satisfies the relations: 0<x≦1, 0≦y<1 and x+y=1; and x′ and y′ each represents the abundance ratio of each repeating unit and satisfies the relations: 0<x′<1, 0 <y′<1 and x′+y′=1.

If both L₁₃ and L₁₄ include methylene, the methylene serving as a spacer group should preferably satisfy the range as stated above. Specifically, the polyester represented by Formula (4) is preferably designed such that in terms of achieving a high degree of sensitivity and a large dynamic range a number (k) of the methylene groups that are represented by L₁₃ is in a range from 2 to 12 and a number (1) the methylene groups that are represented by L₁₄ is in a range from 4 to 20. In particular, k is preferably in a range of from 2 to 4, and 1 is preferably in a range of from 4 to 8.

The polyester represented by Formula (4) may be produced in the presence of a suitable catalyst by the reaction of the dicarboxylic acid monomer represented by Formula (5) below, the photoresponsive dicarboxylic acid monomer represented by Formula (6) below and the diol compound represented by Formula (7) below.

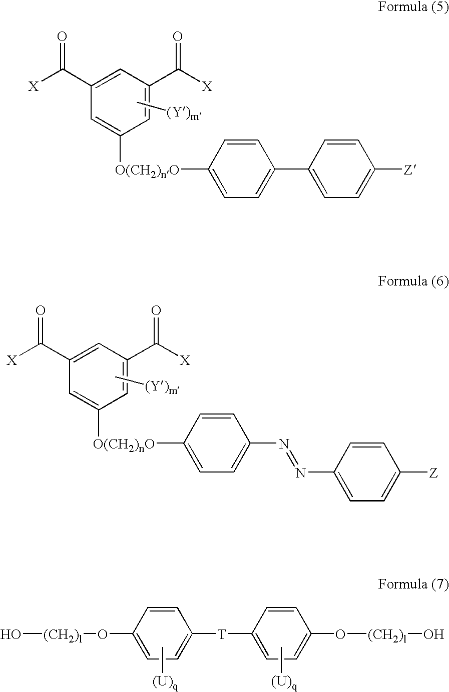

In Formula (7), U represents a hydrogen atom, a halogen atom, a substituted or unsubstituted lower alkyl group, a substituted or unsubstituted lower alkenyl group, or a substituted or unsubstituted lower alkynyl; T represents a sulfone bond, a sulfoxide bond, an ether bond, a thioether bond, a substituted imino bond, or a ketone bond; q represents an integer of 1 to 4; and k and 1 each represents an integer of 2 to 20.

The photoresponsive group-containing polymer or oligomer according to the invention preferably has a number average molecular weight of about 1000 to about 10,000,000, and more preferably of about 10,000 to 1,000,000.

Specific examples of the photoresponsive group-containing polymer or oligomer represented by Formula (1) include, but are not limited to, the following:

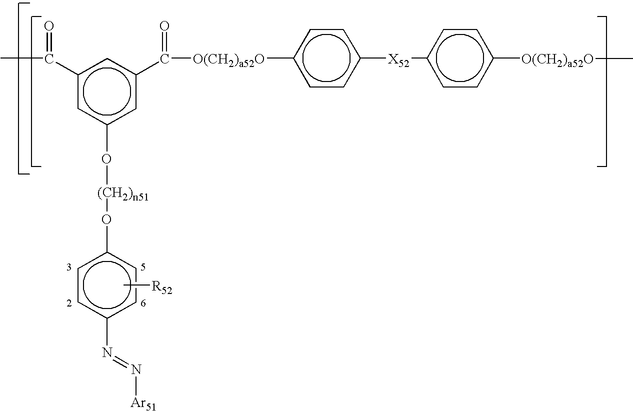

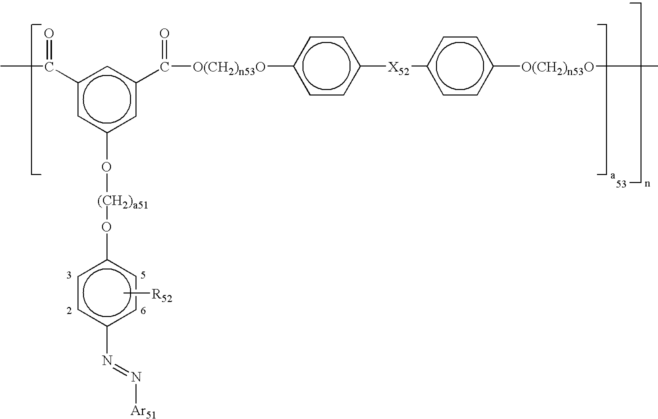

| | | | | | | | |
|---|---|---|---|---|---|---|---|
| Ar₅₁ | R₅₂ | X₅₂ | n₅₁ | n₅₂ | n₅₃ | a₅₁ | a₅₂ |

| | | | | | | | | |
|---|---|---|---|---|---|---|---|---|
| P-46 | 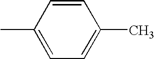 | H | —O— | 4 | 3 | 6 | 0.5 | 0.5 |
| P-47 | 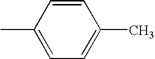 | H | 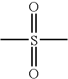 | 4 | 6 | 8 | 0.7 | 0.3 |
| P-48 | 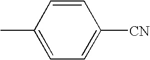 | H | —O— | 6 | 6 | 10 | 0.5 | 0.5 |
| P-49 | 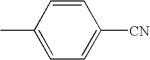 | H | 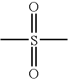 | 6 | 3 | 8 | 0.7 | 0.3 |
| P-50 | 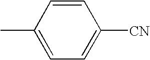 | 3-Cl | 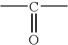 | 6 | 3 | 6 | 0.5 | 0.5 |
| P-51 | 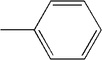 | H | —O— | 6 | 3 | 6 | 0.3 | 0.7 |
| P-52 | 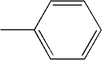 | 2-CH₃ | —S— | 8 | 3 | 8 | 0.5 | 0.5 |
| P-53 | 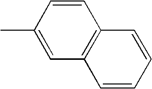 | H | —O— | 6 | 6 | 8 | 0.5 | 0.5 |
| P-54 | 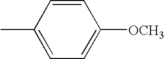 | H | 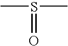 | 6 | 3 | 6 | 0.5 | 0.5 |
| P-55 | 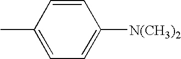 | 3-OCH₃ | 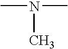 | 6 | 6 | 10 | 0.7 | 0.3 |
| P-56 | 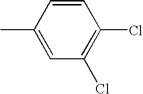 | H | 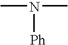 | 6 | 3 | 10 | 0.5 | 0.5 |
| P-57 | 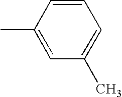 | H | —O— | 6 | 6 | 8 | 0.7 | 0.3 |
| P-58 | 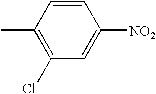 | H | —O— | 8 | 6 | 10 | 0.8 | 0.2 |
| P-59 | 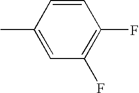 | 3-COOCH₃ | 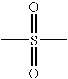 | 6 | 3 | 8 | 0.5 | 0.5 |
| P-60 | 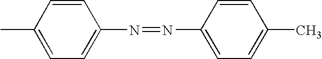 | H | —O— | 6 | 3 | 6 | 0.7 | 0.3 |
| P-61 | 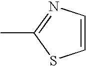 | H | —O— | 6 | 3 | 6 | 0.5 | 0.5 |
| P-62 | 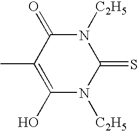 | H | —O— | 6 | 3 | 8 | 0.2 | 0.8 |
| P-63 | 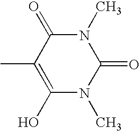 | H | 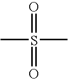 | 6 | 6 | 8 | 0.4 | 0.6 |
| P-64 | 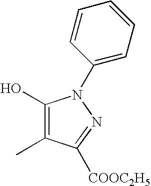 | H | —O— | 6 | 6 | 10 | 0.5 | 0.5 |
| P-65 | 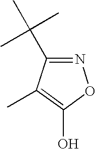 | H | 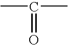 | 6 | 3 | 8 | 0.7 | 0.3 |

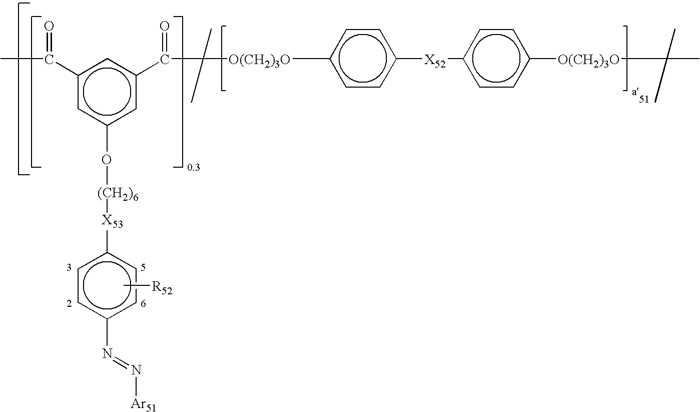

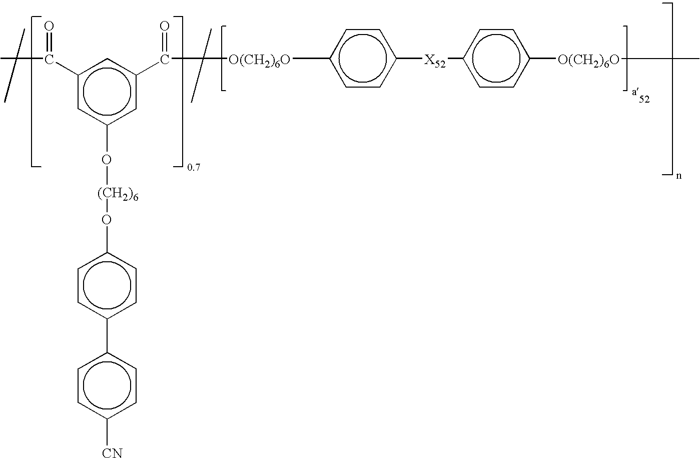

| | Ar₅₁ | R₅₂ | X₅₃ | X₅₂ | a′₅₁ | a′₅₂ |
|---|---|---|---|---|---|---|
| P-66 | 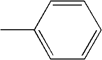 | H | —O— | —O— | 0.5 | 0.5 |
| P-67 | 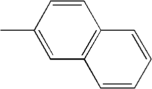 | H | —O— | —O— | 0.9 | 0.1 |
| P-68 | 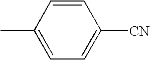 | H | —O— | —O— | 0.9 | 0.1 |
| P-69 | 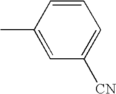 | 3-Cl | —O— | 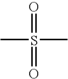 | 0.7 | 0.3 |
| P-70 | 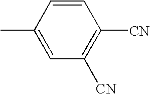 | 3-COOCH₃ | —O— | 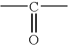 | 0.9 | 0.1 |
| P-71 | 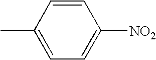 | H | —O— | —O— | 0.5 | 0.5 |
| P-72 | 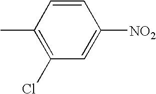 | H | —O— | —O— | 0.9 | 0.1 |
| P-73 | 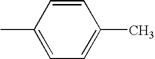 | H | —O— | —O— | 0.7 | 0.3 |
| P-74 | 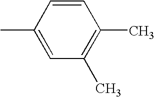 | H | 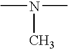 | 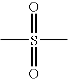 | 0.8 | 0.2 |
| P-75 | 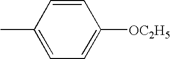 | H | —O— | —O— | 0.5 | 0.5 |
| P-76 | 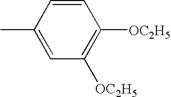 | H | 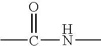 | 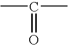 | 0.9 | 0.1 |
| P-77 | 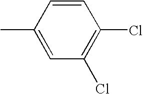 | 2-CH₃ | —O— | —O— | 0.5 | 0.5 |
| P-78 | 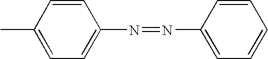 | H | —O— | 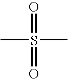 | 0.5 | 0.5 |
| P-79 | 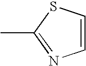 | 2-OCH₃ | —O— | —O— | 0.5 | 0.5 |
| P-80 | 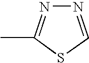 | H | —O— | 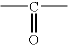 | 0.9 | 0.1 |
| P-81 | 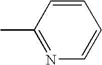 | H | —O— | 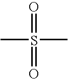 | 0.7 | 0.3 |
| P-82 | 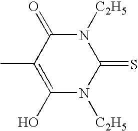 | H₁ | —O— | —O— | 0.9 | 0.1 |
| P-83 | 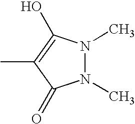 | 2-OCH₃ | —O— | —O— | 0.7 | 0.3 |

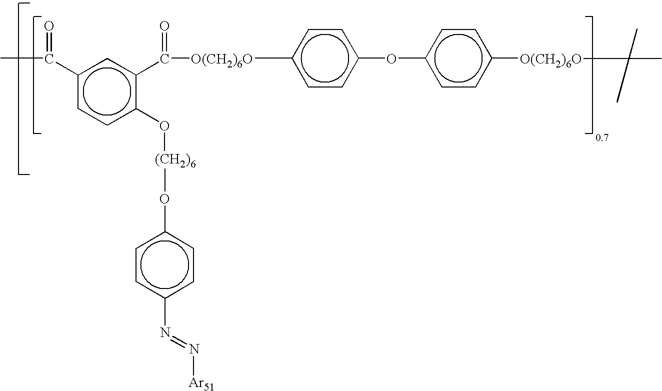

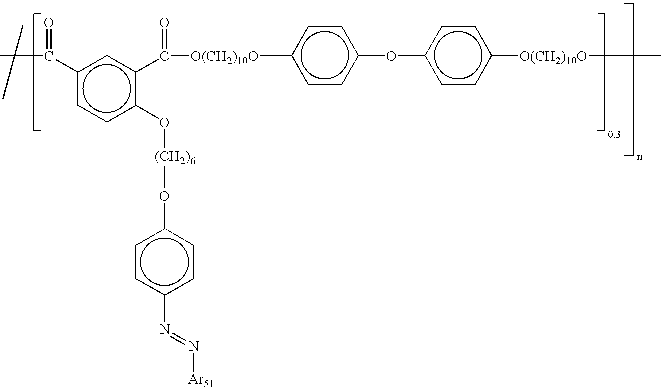

| | Ar₅₁ |
|---|---|
| P-84 | 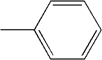 |
| P-85 | 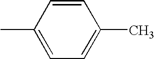 |
| P-86 | 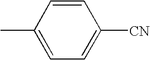 |
| P-87 | 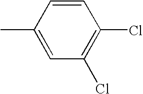 |
| P-88 | 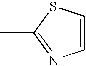 |
| P-89 | 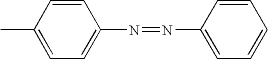 |

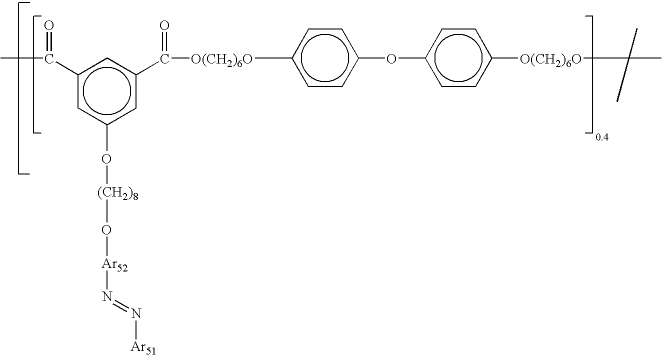

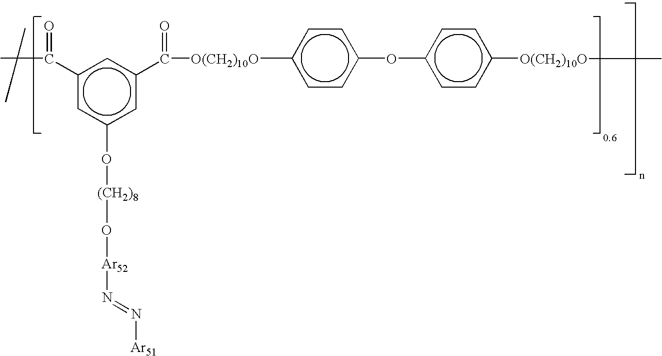

| | Ar₅₂ | Ar₅₁ |
|---|---|---|
| P-90 | 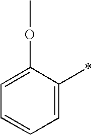 | 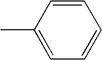 |
| P-91 | 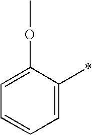 | 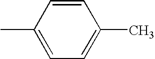 |
| P-92 | 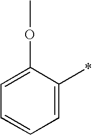 | 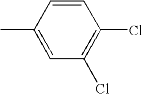 |
| P-93 | 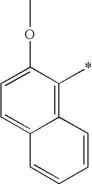 | 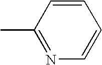 |
| P-94 | 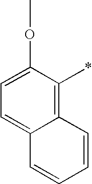 | 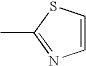 |
| P-95 | 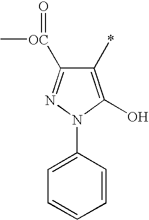 | 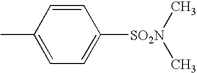 |
| P-96 | 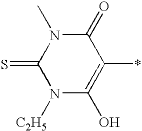 | 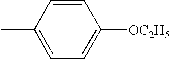 |
| P-97 | 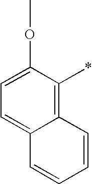 | 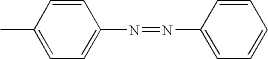 |

The mark * indicates the —N═N— side.

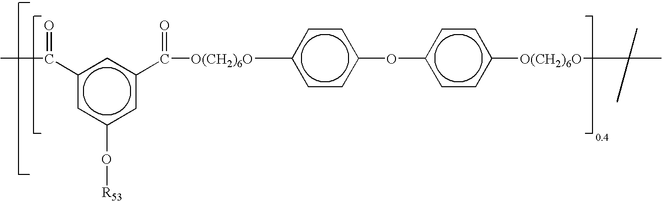

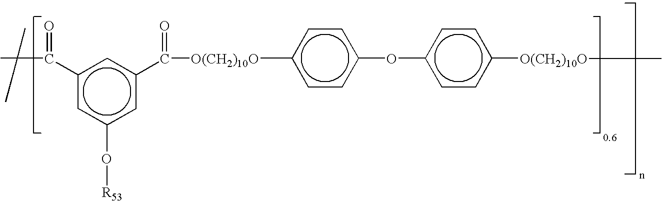

| | R₅₃ |
|---|---|
| P-101 | 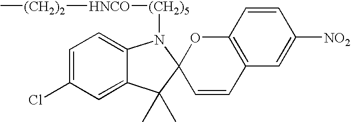 |
| P-102 | 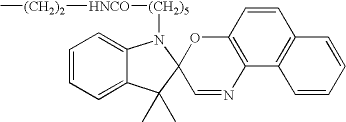 |
| P-103 | 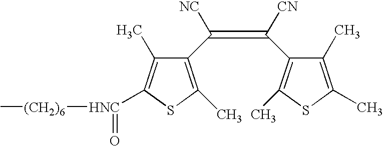 |
| P-104 | 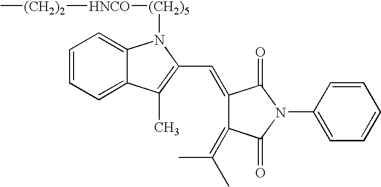 |
| P-105 | 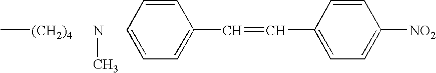 |
| P-106 | 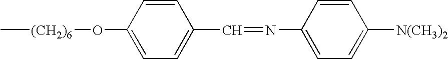 |

These polymers or oligomers may be synthesized on the basis of known synthesis methods as disclosed in JP-A Nos. 2001-294652 and 2000-264962, Japanese Patent Application National Publication (Laid-Open) Nos. 2000-514468 and 2002-539476, U.S. Pat. No. 6,441,113 B1, and JP-A No. 10-212324.

Optical Recording Medium

Structure of Optical Recording Medium

The optical recording medium of the invention includes a photosensitive layer that contains the optical recording material of the invention.

The optical recording medium of the invention may include a substrate and a photosensitive layer containing the optical recording material. A photosensitive layer containing the optical recording material may form the whole of the optical recording medium. Any substrate may be used as long as it is transparent and tough in the operating wavelength range and free from significant variations in quality or size in normal ranges of temperature and moisture. Examples of such a substrate include soda glass, borosilicate glass, potash glass, an acrylic plate, a polycarbonate, and a polyethylene terephthalate (PET) sheet.

The optical recording medium of the invention with the optical recording material makes possible a relatively thick photosensitive layer, a merit which would have been difficult to achieve in related art. The thickness of the photosensitive layer can be varied, with no degradation in optical recording characteristics, within a range of from about 20 μm to about 10 mm. The more the thickness of the photosensitive layer is increased, the more recording multiplicity can also be increased. However, the diffraction efficiency of the multiplexed holograms varies in almost an inverse ratio to the square of the multiplicity. Accordingly, thickness is preferably within a range such that a multiplicity of up to several thousands is possible, and specifically, the thickness is preferably from about 50 μm to about 1000 μm.

In the recording medium of the invention, the abundance ratio of each of the two or more spacer groups which have different lengths and which are introduced into the main chain(s) of the photoresponsive group-containing polymer(s) or oligomer(s) is preferably varied in the film thickness direction (the direction of travel of the recording light from a surface side of the photosensitive layer).

Thus, the photosensitivity of the optical recording medium in the depth direction can be controlled by varying the abundance ratio in the film thickness direction from the surface of the optical recording medium.

In the invention, it is particularly preferable that the abundance ratio of a relatively short main-chain spacer group in the polymer(s) or the oligomer(s) has been increased in the direction of film thickness of the photosensitive layer from a surface side of the photosensitive layer. The intensity of the recording light is attenuated in the direction of travel of the light because of absorption by the medium. However, if the abundance ratio of the short spacer group in the main chain is high, the degree of photosensitivity is high in the travel direction, and attenuation of the refractive index amplitude for the formed hologram can thus be controlled. Accordingly, degradation in angle selectivity on the basis of Bragg condition can be kept under control, and when data is reproduced a high S/N ratio can be achieved.

Within a range of from about 50 to about 1000 μm along the direction of travel of the recording light from the surface of the optical recording medium, in relation to total amount of spacer groups in the main chain(s), the abundance ratio of the short spacer group introduced into the main chain(s) is preferably varied between a range of from about 0 to about 20% by mole and a range of from about 50 to about 100% by mole.

At an operating wavelength the optical recording medium of the invention preferably has a transmittance or reflectivity of from about 40 to about 80%, and more preferably of from about 50 to about 70%. If transmittance or reflectivity is less than about 40%, circumstances can arise when it becomes difficult to achieve a high level of diffraction efficiency because of absorption loss. If, on the other hand, transmittance or reflectivity exceeds about 80%, it can be difficult to achieve a high degree of sensitivity because of a reduction in the amount of the dye.

The optical recording medium of the invention may be formed in either a two or three-dimensional shape such as the shape of a sheet, a tape, a film or a disc. For example, one concrete method of forming the optical recording medium includes the steps of: dissolving the optical recording material in an aliphatic or aromatic, halogenated or ether solvent such as chloroform, methylene chloride, o-dichlorobenzene, tetrahydrofuran, anisole, and acetophenone; and applying the solution to a substrate such as glass to form a transparent, tough, film-shaped, optical recording medium. Alternatively, a film-shaped medium can be formed by heating and compressing a powdered, pelleted or flaked solid of the optical recording material by a method such as hot-press method.

Preferred embodiments of the optical recording medium of the invention include the following: (1) a disc-shaped optical recording medium on, or from, which recording or reproduction can be performed by rotating it and scanning it with a recording/reproducing head along its radius; (2) a sheet-shaped optical recording medium on, or from, which recording or reproduction can be performed by scanning it with a recording/reproducing head in two-dimensional directions; (3) a tape-shaped optical recording medium on, or from, which recording or reproduction can be performed by winding it and scanning a certain part of it with a recording/reproducing head; (4) a three-dimensional bulk-shaped optical recording medium on, or from, which recording or reproduction can be performed by anchoring it or fixing it onto a movable stage and scanning the surface or inside thereof with a movable or fixed recording/reproducing head; and (5) an optical recording medium which contains appropriately-laminated film-shaped components and has a two-dimensional shape such as a disc shape, a sheet shape and a card shape, or alternatively has some other three-dimensional shape and on, or from, which recording or reproduction can be performed by scanning it with a recording/reproducing head based on any one, or any combination, of the methods described in the above items (1) to (4).

Applicable Recording Methods

The optical recording medium of the invention is for use in optical recordings which are effected by means of a change, or variation, in absorption, refractive index or shape of the optical recording material that take place when light, or heat, is applied to the optical recording material. Examples of such an optical recording method include holographic recording, light absorbance modulation recording, light reflectance modulation recording, and photo-induced relief formation. In particular, the optical recording medium of the invention is suitable for holographic recording, a process which can be performed on the basis of the amplitude, phase and polarization direction of object light. When the optical recording medium of the invention is used, recording with parallel polarization directions of incident object light and reference light can be performed independently of recording with perpendicular polarization directions of incident object light and reference light. The polarization arrangement of the two lightwaves in holographic recording is not limited to those stated above. Any other arrangement may be selected, as long as it can produce optical intensity distribution or polarization distribution by means of interference.

Optical Recording/Reproducing Device

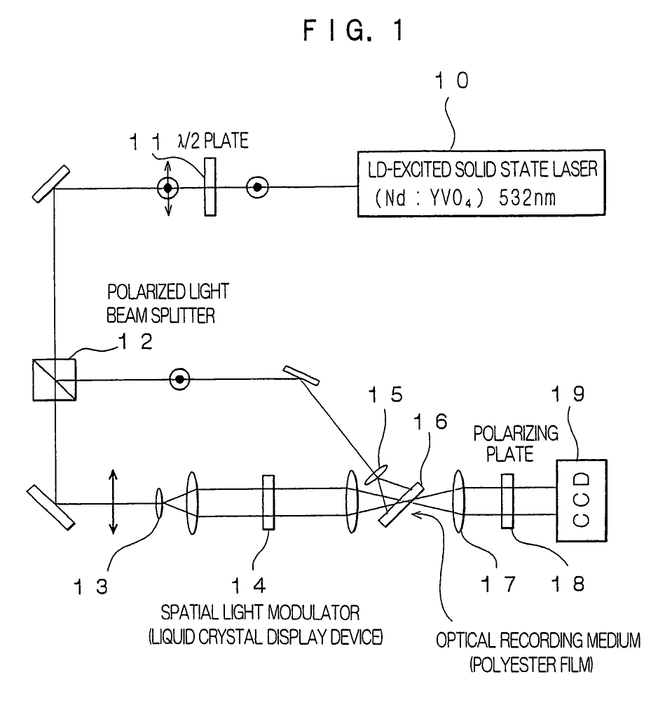

FIG. 1 illustrates an example of the optical recording/reproducing device of the invention.

This example uses an oscillation line with a wavelength of 532 nm from a laser diode-excited solid state laser. The laser beam emitted from the solid state laser 10 passes through a ½ wave plate 11 and is transmitted to a polarized beam splitter 12 to be divided into two lightwaves, signal light and reference light. The signal light is expanded and collimated by a lens system 13 and passes through a spatial light modulator 14. At this time, certain data which has been encoded in accordance with the information is expressed by light and shade on a liquid crystal display (the spatial light modulator 14) and imparted to the signal light. The signal light is then Fourier-transformed by a lens and applied to an optical recording medium 16. The reference light is formed into a spherical wave through a lens 15 placed immediately before the optical recording medium 16 and applied to the optical recording medium 16 so as to be superposed on the signal light in the medium 16. Thus, the information imparted to the signal light is recorded into the optical recording medium in the form of a hologram.

As for the thick hologram, as mentioned above, volume-multiplexed recording is possible by hologram selectivity on the basis of the incident angle of reference light. When recording is performed with the use of a spherical reference wave, shifting the record medium in a surface direction is in practice tantamount to varying the incident angle of reference light onto an effectively recorded hologram. Thus, if recording is performed while the optical recording medium 16 is being shifted in a situation in which the paths of signal light and reference light are fixed, volume-multiplexed recording can easily be achieved. This example illustrates a spherical reference wave-shift multiplexing method. However, the multiplexing method is not limited to such a method, and any other multiplexing method, such as angle multiplexing, polarization angle multiplexing, correlation multiplexing, and wavelength multiplexing may also be used.

The light source may emit coherent light to which the recording layer (photosensitive layer) of the optical recording medium 16 is sensitive. In a case where the optical recording material of the invention is used for the recording layer, the light source is preferably a laser diode-excited solid state laser with an oscillation wavelength of 532 nm, or an argon ion laser with an oscillation wavelength of 515 nm, wherein the oscillation wavelength corresponds to the edge of the absorption peak of the optical recording medium 16.

The spatial light modulator 14 used may be a transmission type spatial light modulator which contains an electro-optical converting material such as a liquid crystal, and transparent electrodes formed on both sides of the electro-optical converting material. Such a type of spatial light modulator may be a liquid crystal panel for use in a projector.

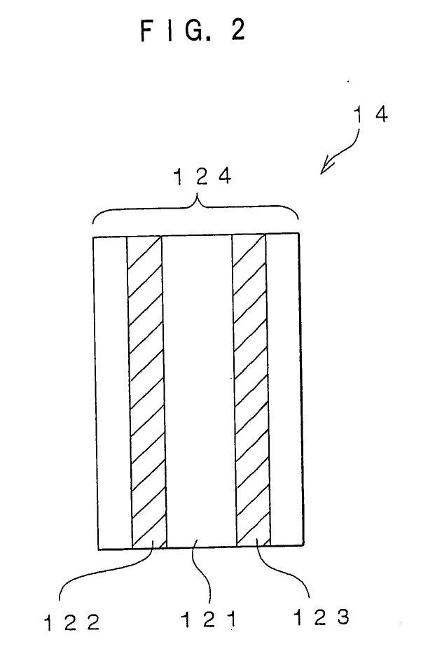

However, if polarization modulation is to be performed with the use of the liquid crystal panel as a projector, at least a polarizing plate placed on the output side must be removed. As shown in FIG. 2, for example, the spatial light modulator 14 may be a transmission type liquid crystal cell 124 which contains a liquid crystal 121, which is an electro-optical converting member, and electrodes 122 and 123 formed on both sides of the liquid crystal 121. In this spatial light modulator for polarization modulation, multiple two-dimensional pixels are arranged, and each pixel is allowed to function as a ½ wave plate. In accordance with the two-dimensional data, bit information is provided as an indication of whether or not applied voltage exists for each pixel, and polarization of incident light on each pixel can be modulated. With the use of a spatial light modulator of this kind, information can thus be recorded through polarization modulation in which signal light is encoded in a polarization direction.

Reproduction is performed by applying only reference light to the optical recording medium 16. Diffracted light is Fourier-transformed by a lens 17. A component with a polarization angle desired is selected by the polarizing plate 18, thus enabling an image to be formed on a CCD camera 19. The intensity distribution reproduced by the CCD camera 19 is binarized with a sustainable threshold value and decoded by an appropriate method so that the recorded information is reproduced.

The recording device and the reproduction device may be integrated as shown in FIG. 1, or alternatively each may be independently constructed. The light source for reproduction may use the same wavelength as that of the recording light. Alternatively, the light source for reproduction may be something akin to a helium-neon laser with an oscillation wavelength of 633 nm to which the recording layer is not sensitive (or shows no absorption). It accordingly becomes possible for the recorded information to be read out without being destroyed.

As described above, a thick highly sensitive medium for achieving a high level of diffraction efficiency can be produced with the use of the optical recording material of the invention. Such a medium can significantly enhance volume multiplicity in holographic recording and can thus be used as a large-capacity optical recording medium. Additionally, the direction of the polarization of signal light can be recorded on the optical recording medium of the invention. Accordingly, on the basis of polarization recording, the medium can be used as either a large-capacity recording method or as a light-processing method. A large-capacity optical recording/reproducing device which can use any of these optical recording media can also be provided.

### EXAMPLES

The present invention is more specifically described with reference to the examples below.

Holographic Recording Characteristics

Synthesis of Photoresponsive Polyester with Main Chain Having Two Spacer Groups Different in Length

Into a 300 ml three-neck flask equipped with an evacuator and a stirrer are added 0.003 mol of diethyl 5-{6-[4-(4-methylphenylazo)phenoxy]hexyloxy}isophthalate (a photoresponsive dicarboxylic acid monomer bearing methylazobenzene), 0.007 mol of diethyl 5-{6-[4-(4-cyanophenyl)phenoxy]hexyloxy}isophthalate (a dicarboxylic acid monomer bearing cyanobiphenyl), 0.005 mol of 6,6′-(4,4′-sulfonyldiphenylenedioxy)dihexanol, 0.005 mol of 6,6′-(4,4′-sulfonyldiphenylenedioxy)didecanol, and 0.1 g of zinc acetic anhydride. The materials are allowed to react at 160° C. for two hours and at about 1.3×10³ Pa for 20 minutes while stirred and heated under a nitrogen atmosphere.

The pressure is then gradually reduced to about 2.7×10² Pa over 30 minutes while the materials are heated to 180° C. After the reaction is completed, the reaction product is dissolved in chloroform, and the resultant solution is poured into methanol so that the product is again precipitated. The resultant crude polymer is again separated and subjected to the precipitation process, and then boiled and washed with hot methanol and hot water, separated by filtration, and dried under reduced pressure to give the desired photoresponsive polyester with a number average molecular weight of 11250 in a yield of 65%.

The resultant photoresponsive polyester 1 (XSO6SO10YCH6CB6) has the structure represented by the formula: 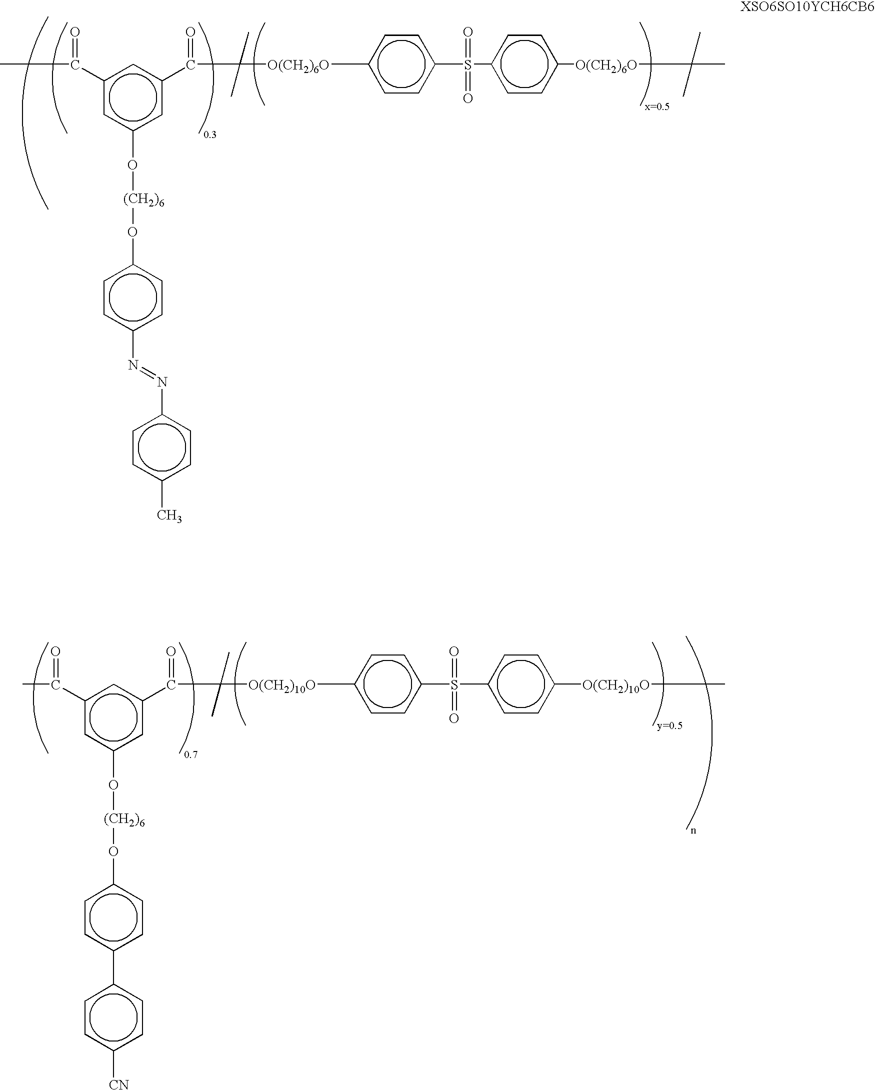
Preparation of Optical Recording Medium

The flaky photoresponsive polyester 1 is placed on a cleaned glass substrate, and another glass substrate is placed thereon. The photoresponsive polyester 1 and the two substrates are heated and pressed under reduced pressure, resulting in a sandwich type glass cell medium containing photoresponsive polyester 1 (the optical recording material) sandwiched between the two glass substrates. During this process, the thickness of the optical recording material layer is controlled to 250 μm with the use as a spacer of a film with the same thickness as the optical recording material layer. In the glass cell medium prepared as described above, the optical recording material is able to form a transparent uniform film with neither scattering nor air bubble. The resultant glass cell medium is from now on described as optical recording medium A. The transmittance of optical recording medium A with an optical recording material layer of photoresponsive polyester 1 is measured with the use of a 532 nm laser light and found to be 53%.

Holographic Recording Characteristics

Holographic recording is next performed with the use of optical recording medium A.

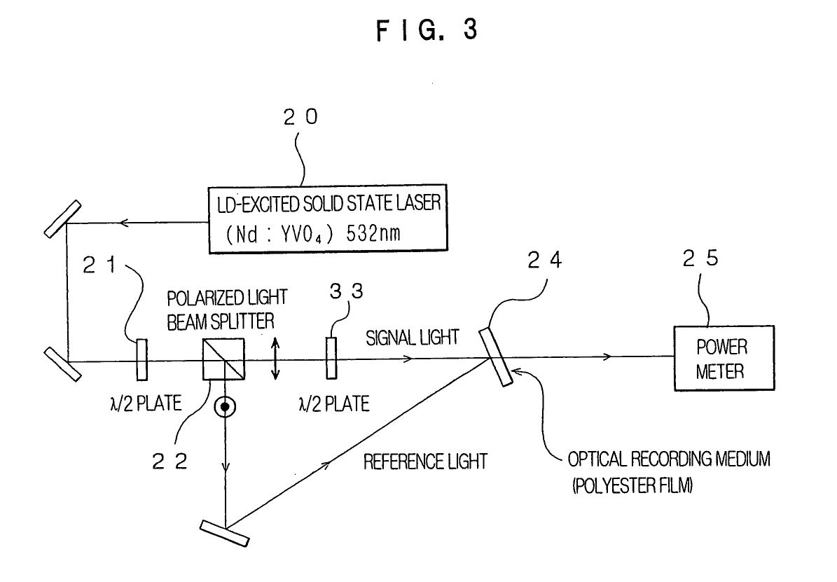

FIG. 3 shows an optical system (optical recording/reproducing device) used in the holographic recording. As shown in FIG. 3, recording/reproducing is performed with the use of a 532 nm oscillation line of a laser diode-excited solid state laser. The polarization of the linearly polarized light emitted from the solid state laser is rotated by a ½ wave plate, and then the light is divided by a polarized light beam splitter into two lightwaves, signal light and reference light. At this time, the intensity balance between the two lightwaves may be adjusted by controlling the rotation angle of the polarization. The two lightwaves are formed to cross each other in the optical recording medium and induce optical anisotropy in the medium in accordance with intensity distribution or polarization distribution produced by interference between the two lightwaves. The ½ wave plate on the path of the signal light controls the polarization of the signal light so that intensity-modulated holographic recording with parallel polarization directions of signal light and reference light, and polarization-modulated holographic recording with perpendicular polarization directions of signal light and reference light, can be performed.

In the reproduction, only reference light is applied to the optical recording medium to produce diffracted light from the recorded hologram, and the light output can be measured with a power meter. The diffraction efficiency of the optical recording medium can be calculated by determining the ratio of the diffracted light intensity to the reference light intensity.

Holographic recording is performed on optical recording medium A in the above optical system. As a result, recording of an intensity-modulated hologram is possible when the polarization directions of the signal light and the reference light are parallel to each other, and recording of a polarization-modulated hologram is possible when the polarization directions of the signal light and the reference light are perpendicular to each other. In both cases, the maximum diffraction efficiency reaches 27%.

Recording/reproducing of digital data on/from optical recording medium A is performed using the optical recording/reproducing device as shown in FIG. 1. Specifically, 162 KB digital data is divided into 30 pages of data (each page corresponds to 800×660 pixels of the spatial light modulator) and subjected to multiplexed recording. During this process, the recording light intensity is 200 mW/cm², and the average recording time per one hologram is 150 msec. The reproduced two-dimensional digital data page is decoded so that the recorded digital data can be reproduced. Thus, the thick medium prepared with a film thickness of 250 μm can achieve a high degree of sensitivity and a high level of diffraction efficiency.

Birefringence Recording by Application of Linearly Polarized Light Synthesis and Preparation of Optical Recording Material

Two photoresponsive polyesters whose main-chain spacers are different in length are synthesized using the same process as that described in the above section “Synthesis of Photoresponsive Polyester” in “Holographic Recording Characteristics.” Specifically, equal parts (equal moles) of diethyl 5-{6-[4-(4-cyanophenylazo)phenoxy]hexyloxy}isophthalate (a cyanobenzene-bearing photoresponsive dicarboxylic acid monomer for a side chain part) and 6,6′-(4,4′-sulfonyldiphenylenedioxy)dihexanol (a monomer for a main chain part) are allowed to react to form photoresponsive polyester 2 with a number average molecular weight of 12508. On the other hand, equal parts (equal moles (each 0.005 mol)) of diethyl 5-{6-[4-(4-cyanophenylazo)phenoxy]hexyloxy}isophthalate (for a side chain part) and 6,6′-(4,4′-sulfonyldiphenylenedioxy)didecanol (for a main chain part) are allowed to react to form photoresponsive polyester 3 with a number average molecular weight of 11150.

Photoresponsive polyester 2 (XO6YCN6) having a relatively short spacer in its main chain part and photoresponsive polyester 3 (XO10YCN6) having a relatively long spacer in its main chain part, respectively, have the structures represented by the formulae:

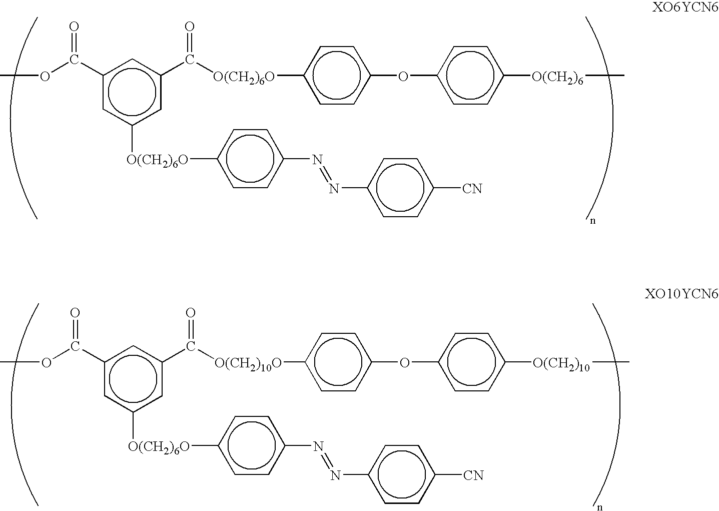

Each of photoresponsive polyesters 2 and 3 is used alone as an optical recording material. The two polymers whose main-chain spacers are different in length are also used in the form of a mixture. Specifically, three types of polymer blends (corresponding to the optical recording material of the invention) are produced with polyester 2/polyester 3 blend ratios of 0.25, 0.50 and 0.75, respectively. Each blend is prepared by a process of mixing and dissolving the materials in a solvent at the same time as the solution for forming the optical recording medium is prepared as shown below.

Preparation of Optical Recording Medium

Optical recording media are prepared using each of the two polymers (photoresponsive polyesters 2 and 3) alone. Optical recording media are also prepared using each of the three polymer blends. Each optical recording material is dissolved in chloroform at a concentration of 0.1 g/ml. Each solution is applied to a cleaned glass substrate by spin coating under conditions of 1000 rpm and 10 sec. After it is dried, the coating is measured for thickness with a stylus-type surface roughness meter and found to be a thin film with a thickness of from 1.5 to 2 μm. The surface of the coating is uniform. The coating is heated and rapidly cooled to form a transparent amorphous film with no scattering.

The resultant optical recording media having optical recording material layers of photoresponsive polyesters 2 and 3, respectively, are respectively described from now on as optical recording media B and C. The three media produced with the polymer blends with polyester 2 polyester 3 blend ratios of respectively 0.25, 0.50 and 0.75 are from now on respectively described as optical recording media D, E and F.

Birefringence Recording Characteristics

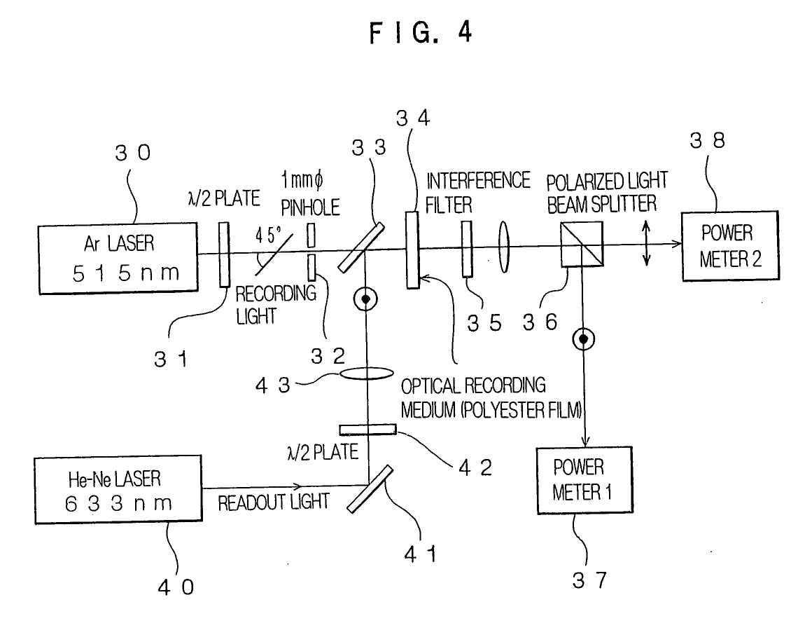

FIG. 4 shows an optical system for use in the birefringence recording by the application of linearly polarized light. As illustrated in FIG. 4, linearly polarized light (7.9 mW) with a wavelength of 515 nm, to which the polymer of the optical recording medium 34 is sensitive, is emitted as recording light from an argon ion laser 30 and transmitted to the medium 34 via a ½ wave plate 31, a pinhole 32 and a half mirror 33. On the other hand, linearly polarized light with a wavelength of 633 nm is emitted as readout light from a helium-neon laser 40 and transmitted via a mirror 41, a ½ wave plate 42, a lens 43, and a half mirror 33 into the medium 34 at an angle of 45° with respect to the polarization axis. The laser light passing through the optical recording medium 34 passes through an interference filter 35 and is separated by a polarized light beam splitter 36 into polarized light components whose polarization directions are perpendicular to each other. The optical power of each polarized light component is respectively measured with two power meters 37 and 38. Using measurement values from the two power meters 37 and 38, a change in birefringence is calculated from the polarization state of the transmitted light.

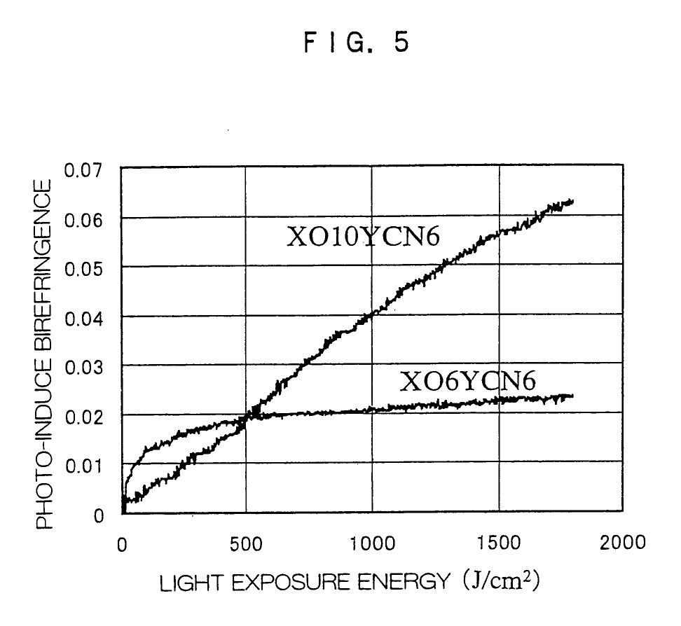

In the optical system as shown in FIG. 4, birefringence is recorded onto each of optical recording media B and C, which has each been produced with one of photoresponsive polyesters 2 and 3. FIG. 5 shows photo-induced birefringence in relation to light exposure energy. As illustrated in the drawing, both growth curves of photo-induced birefringence are compared in terms of the sensitivity indicated by the initial slope and dynamic range indicated by the saturation value. This comparison reveals that photoresponsive polyester 2 (XO6YCN6) with a relatively short main-chain spacer has a high degree of sensitivity but a narrow dynamic range, and that photoresponsive polyester 3 (XO10YCN6) with a relatively long main-chain spacer has a large dynamic range but a low degree of sensitivity. Both characteristics are important in terms of enhancing recording speed and recording density, but as shown above, conventional optical recording materials can hardly satisfy both characteristics at the same time, and it can thus be argued that it is difficult to control the characteristics of such materials on the basis of specifications desired.

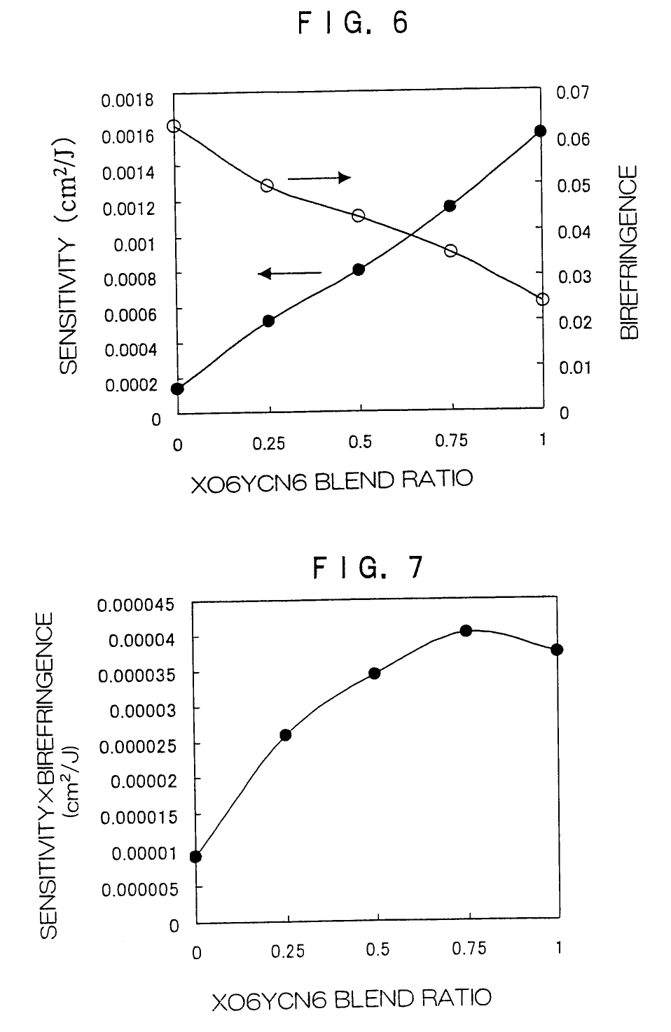

Birefringence recording is also performed on each of the three optical recording media C, D and E, which have respectively been produced with the three optical recording materials (polymer blends) according to the invention, in the same manner as in the case of optical recording media B and C. FIG. 6 illustrates the results of plotting the sensitivity and recorded birefringence value against the blend ratio of XO6YCN6. As FIG. 6 reveals, sensitivity and birefringence can easily be regulated by varying the blend ratio. According to the invention, therefore, materials can easily be designed according to the specifications desired.

FIG. 7 illustrates the results of plotting (sensitivity×birefringence) in relation to the blend ratio. In FIG. 7, the higher the value on the ordinate axis, the more both characteristics can be said to be satisfied at the same time. The graph, moreover, reveals that (sensitivity×birefringence) reaches a maximum value at a certain blend ratio. With the use of the optical recording material of the invention, therefore, it is possible to enhance both sensitivity and dynamic range at the same time.

Multiplexed Holographic Recording Characteristics

A description is provided below of an example of a design of the optical recording medium capable of achieving both a high S/N ratio and a high recording density based on a structure in which in the optical recording medium the abundance ratio of each of the two or more spacer groups having different lengths in the main chain(s) is varied in the film thickness direction.

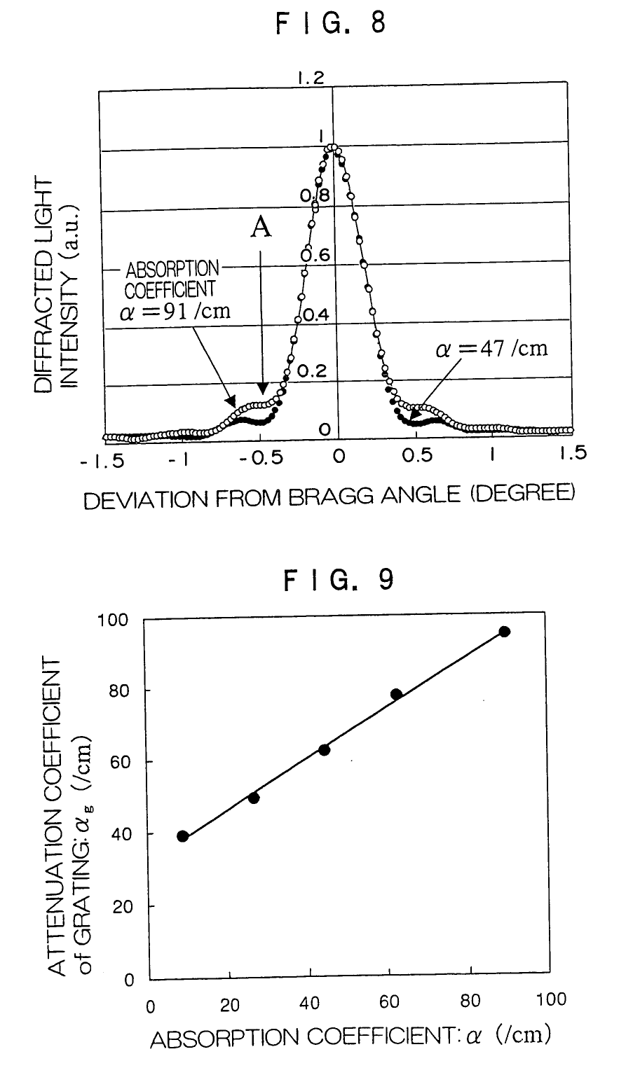

Photoresponsive polyester 2 and a non-photoresponsive polyester are blended to form a polymer blend, wherein the non-photoresponsive polyester is a compound derived of photoresponsive polyester 2, in which cyanobiphenyl is substituted for all the cyanoazobenzene of photoresponsive polyester 2. The polymer blend is used to form optical recording media G and H (conventional optical recording media) each having a 250 μm thick film. In the optical system as shown in FIG. 3, a hologram is recorded onto each of optical recording media G and H. The intensity of the diffracted light at the time when 633 nm laser light is applied to the hologram is plotted in relation to deviations from the incident angle that satisfies the Bragg condition, and the results as illustration in FIG. 8 are obtained. The graph illustrates the results of two experiments using optical recording materials which are different in their absorption coefficient α. Ideally, the diffracted light intensity should be zero at the angle indicated by “A” in the graph, and if another hologram is recorded at such an angle, multi-recorded hologram signals can be read out with no crosstalk. As shown in FIG. 8, however, the diffracted light intensity at angle “A” increases in relation to the absorption coefficient α of the optical recording material, and crosstalk can accordingly occur between the multi-recorded hologram pieces.

As an explanation of this effect, the results of the experiments can be interpreted by introducing the attenuation coefficient α_{g} of the refractive index amplitude in the film thickness direction of the optical recording medium (the attenuation coefficient of the grating) into the theoretical equation disclosed in the literature, N. Uchida, J. Opt. Soc. Am. 63, pp. 280-287, 1973. FIG. 9 shows the plot of the attenuation coefficient α_{g} of the grating, which is calculated by means of the theoretical equation, in relation to the absorption coefficient α of the optical recording material. The graph shows that the attenuation coefficient α_{g} of the grating has a substantially linear relation to the absorption coefficient α of the optical recording material and that attenuation of the grating can occur when recording light intensity is attenuated as a result of absorption by the optical recording medium.

On the other hand, the optical recording medium of the invention may be designed such that the abundance ratio of each of the two or more spacer groups having different lengths introduced into the main chain(s) varies in the film thickness direction and that the abundance ratio of the photoresponsive group with the relatively short spacer increases in a direction from the film surface to the film bottom.

As already described with reference to FIG. 5 concerning the photo-induced birefringence characteristics, the shorter spacer of the main chain can produce a higher degree of photosensitivity and can thus produce sufficient amplitude of refractive index even when the recording light intensity is attenuated because of absorption by the medium. The attenuation coefficient α_{g} of the grating can accordingly be reduced, and crosstalk between multiplexed holograms can be reduced. For this purpose, the abundance ratio of the main-chain spacer length is preferably varied such that the product (I×S) of the recording light intensity (I) and the sensitivity (S) is constant in the film thickness direction. For example, the recording light intensity (I) can be determined by the formula: I=I₀exp(−αx), wherein x is a position inside the medium in the thickness direction, and I₀ is the recording light intensity at the uppermost surface. Thus, in order to keep I×S constant, the film should preferably be formed such that sensitivity (S) is in proportion to exp(ax).

Based on this strategy, an optical recording medium is prepared using photoresponsive polyester 3 (XO6YCN6) and photoresponsive polyester 2 (XO10YCN6) according to the invention. First, a polymer film of each photoresponsive polyester is formed on a glass substrate by hot pressing so as to produce a thickness of 150 μm. The glass substrates are then laminated with a 250 μm thick film spacer interposed there between such that both polymer surfaces are brought into contact with each other, and they are pressed at a temperature of 70° C. so that optical recording medium I is obtained.

In the optical system (optical recording/reproducing device) as shown in FIG. 3, holograms are recorded onto the photoresponsive polyester 3 (XO10YCN6) side of optical recording medium I. With respect to the intensity of the diffracted light incident at the Bragg angle, the intensity of the diffracted light at a deviation angle of 0.5 can be reduced to 1/22 of that of the optical recording medium I produced with photoresponsive polyester 3 (XO10YCN6) alone. According to the invention, therefore, the medium can be designed such that the deeper the position from the film surface the higher a sensitivity can be obtained. Thus, attenuation of the amplitude of the refractive index can be reduced, even if recording light intensity is attenuated because of absorption. Thus, it is possible to reproduce information with a high S/N ratio when the information is reproduced from multiplexed holograms.

1. An optical recording material for recording information on the basis of a photoirradiation-induced change in absorption, refractive index or shape, comprising:
a photoresponsive group-containing polymer or polymers or a photoresponsive group-containing oligomer or oligomers,
the polymer or the polymers or the oligomer or the oligomers comprising a main chain or main chains and a mesogen group-containing side chain or side chains linked to the main chain or main chains, wherein
at least two main-chain spacer groups having flexibility and different lengths are introduced into the main chain or into the main chains.

2. The optical recording material of claim 1, wherein all or part of the mesogen group is a photoresponsive group.

3. The optical recording material of claim 1, wherein a main chain is obtained by mixing and linking polymers or oligomers into which main-chain spacer groups having flexibility and different lengths have been introduced.

4. The optical recording material of claim 1, wherein
a main chain contains an organic group having a cyclic structure,
a photoresponsive group is contained in a side chain, and
all or part of the side chain is linked to all or part of the organic group.

5. The optical recording material of claim 1, wherein
the side chains include (i) a first side chain containing a mesogen group serving as a photoresponsive group and (ii) a second side chain containing a mesogen group serving as a non-photoresponsive group,
the first side chain (i) is linked to a main chain having a first main-chain spacer group,
the second side chain (ii) is linked to a main chain having a second main-chain spacer group, and
the first and second main-chain spacer groups differ in length.

6. The optical recording material of claim 5, wherein the first main-chain spacer group is shorter in length than the second main-chain spacer group.

7. The optical recording material of claim 1, wherein a concentrated content of the photoresponsive group is at most 20% by mass relative to a total amount of the optical recording material.

8. The optical recording material of claim 1, wherein a photoresponsive group-containing polymer or oligomer is a compound represented by Formula (1): 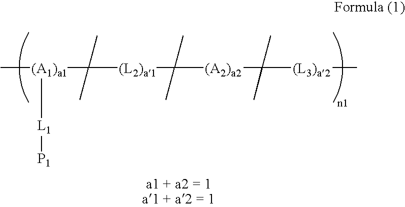
wherein each of L₁ to L₃ represents a bivalent linking group; R₁ represents a hydrogen atom or a substituent; P₁ represents a photoresponsive moiety-containing group; a1 is from 0.0001 to 1; a2 is from 0 to 0.9999; a′1 is from 0.0001 to 0.9999; a′2 is from 0.0001 to 0.9999; n1 is an integer of 4 to 2000; and each of A₁ and A₂ is represented by any one of Formulae (2-1) to (2-4): 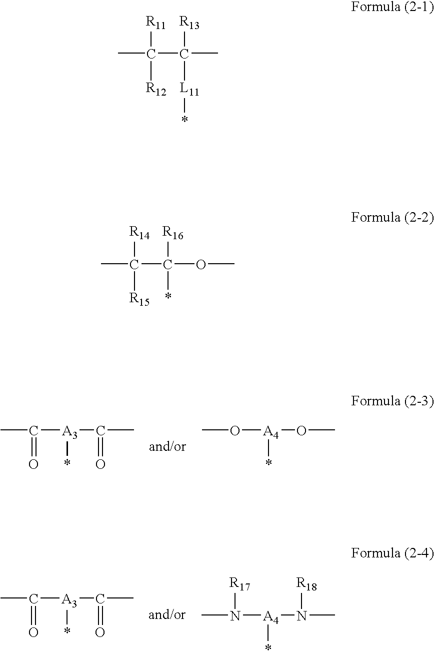
wherein a mark * indicates a position where L₁ or R₁ is to be linked; in Formula (2-1), R₁₁ to R₁₃ each independently represents a hydrogen atom or a substituent; L₁₁ represents an optionally substituted arylene group or any one of —O—, —OC(O)—, —CONR₁₉—, and —COO— wherein the left side of each group is linked to a main chain, the right side of each group is linked to L₁ or R₁, and R₁₉ represents any one of a hydrogen atom, an alkyl group, an alkenyl group, a cycloalkyl group, an aryl group, and a heterocyclic group; each of R₁₄ to R₁₆ independently represents a hydrogen atom or a substituent; each of A₃ and A₄ independently represents a trivalent linking group; and each of R₁₇ and R₁₈ independently represents any one of a hydrogen atom, an alkyl group, an alkenyl group, a cycloalkyl group, an aryl group, and a heterocyclic group.

9. An optical recording medium, comprising a photosensitive layer which contains an optical recording material for recording information on the basis of a photoirradiation-induced change in absorption, refractive index or shape,
the optical recording material containing a photoresponsive group-containing polymer or polymers or a photoresponsive group-containing oligomer or oligomers,
the polymer or the polymers or the oligomer or the oligomers comprising a main chain or main chains and a mesogen group-containing side chain or side chains linked to the main chain or to the main chains, wherein
at least two main-chain spacer groups having flexibility and different lengths are introduced into the main chain or into the main chains.

10. The optical recording medium of claim 9, wherein an abundance ratio of each of the at least two main-chain spacer groups in the polymer or the polymers or the oligomer or the oligomers is varied in a film thickness direction of the photosensitive layer.

11. The optical recording medium of claim 10, wherein the abundance ratio of a relatively short main-chain spacer group in the polymer or the polymers or the oligomer or the oligomers has been increased in the direction of film thickness of the photosensitive layer from a surface side of the photosensitive layer.

12. The optical recording medium of claim 9, wherein the photosensitive layer has a thickness of about 20 μm to about 10 mm.

13. The optical recording medium of claim 9, wherein a transmittance or a reflectivity thereof is from about 40% to about 80%.

14. The optical recording medium of claim 9, which is holographic-recordable.

15. The optical recording medium of claim 9, wherein holographic recording in each of a case where polarization directions of incident object light and reference light are parallel to each other and a case where polarization directions of incident object light and reference light are perpendicular to each other is independently possible.

16. The optical recording medium of claim 9, wherein holographic recording is possible on the basis of amplitude, phase and polarization direction of object light.

17. An optical recording/reproducing device, which uses an optical recording medium in recording and/or reproducing information,
the optical recording medium comprising a photosensitive layer which contains an optical recording material for recording information on the basis of a photoirradiation-induced change in absorption, refractive index or shape,
the optical recording material containing a photoresponsive group-containing polymer or polymers or a photoresponsive group-containing oligomer or oligomers,
the polymer or the polymers, or the oligomer or the oligomers, comprising a main chain or main chains and a mesogen group-containing side chain or side chains linked to the main chain or to the main chains, wherein
at least two main-chain spacer groups having flexibility and different lengths are introduced into the main chain or into the main chains.
